(19) United States
(12) Patent Application Publication
(10) Pub. No.: US 2005/0001878 A1
(43) Pub. Date: Jan. 6, 2005

(54) Printing apparatus, print head, and printing method

(75) Inventors: Keigo Yamasaki, Nagano-ken (JP); Hirokazu Nunokawa, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/819,344

(22) Filed: Apr. 7, 2004

(30) Foreign Application Priority Data
Apr. 10, 2003 (JP) 2003-106588
Apr. 10, 2003 (JP) 2003-106587
Apr. 5, 2004 (JP) 2004-110722

(51) Int. Cl. B41J 2/21

(52) U.S. Cl. 347/43

(57) ABSTRACT

A printing apparatus, a print head, and a printing method with which clear ink can be printed at an appropriate timing are provided. A printing apparatus has, for example: a carrying mechanism for carrying a medium in a carrying direction; and a print head having a plurality of nozzles for ejecting ink to form dots on the medium carried by the carrying mechanism, wherein the print head includes: a first nozzle row having a plurality of nozzles that are for ejecting ink not having color material and that are arranged in the, carrying direction; and a second nozzle row having a plurality of nozzles that are for ejecting ink having color material and that are arranged in the carrying direction, and wherein the first nozzle row is arranged at least on one of an upstream side and a downstream side of the second nozzle row in the carrying direction.

### CROSS-REFERENCE TO RELATED APPLICATIONS

The present application claims priority upon Japanese Patent Application No. 2003-106587 filed on Apr. 10, 2003, Japanese Patent Application No. 2003-106588 filed on Apr. 10, 2003, and Japanese Patent Application No. 2004-110722 filed on Apr. 5, 2004, which are herein incorporated by reference.

### BACKGROUND OF THE INVENTION

1. Field of the Invention

The present invention relates to printing apparatuses, print heads, and printing methods.

2. Description of the Related Art

Inkjet printers are one type of device for outputting images processed by a computer or images captured by a digital camera. Inkjet printers print images by ejecting ink to form dots on a print medium.

Inkjet printers use ink that is created by dissolving, for example, dye or pigment in a solvent, but in recent years, printing properties have been improved by using ink that has specific functions and that does not include color material such as dye or pigment (herein, referred to as “clear ink”). More specifically, clear ink is used with the following objectives in mind:
(1) Correcting unevenness in luster;
(2) Correcting ink bleeding, etc.; and
(3) Improving the printing speed.

First, the item (1) “correcting unevenness in luster” is described.

Generally, pigment-based ink has a high degree of luster (the proportion of light incident at a fixed angle that is reflected at the same diagonal), and thus, differences in the degree of luster occur if areas of high and low dot density are mixed, and these cause unevenness in luster and give an unnatural feeling to the image. FIG. 9A is a diagram that schematically shows a cross section of a dot formed by a dye-based ink. Further, FIG. 9B is a diagram that schematically shows a cross section of dots formed by a pigment-based ink.

As shown in FIG. 9A, dye-based ink 301 favorably permeates into a print medium (for example, print paper) 300. In contrast, as shown in FIG. 9B, pigment-based ink 302 and 303 does not easily permeate into the print medium 300, and thus, at sections where the color is very dark (that is, sections to which an extremely large amount of pigment ink adheres), islands of pigment ink 303 are formed on and thickly cover the surface of the print medium 300, thereby completely obscuring the texture of the surface of the print medium 300.

The light reflectance is generally low at surface portions 300a and 302a, which are areas of very bright color where the texture of the surface of the print medium 300 is favorably exposed, whereas the light reflectance is relatively high at a surface 303a of an island of the pigment ink 303, which is an area of extremely dark color, due to the properties of the ink. Thus, when the surface portions 300a and 302a, which have low light reflectance, and the surface 303a, which has high light reflectance, are adjacent to one another, then the surface 303a of a section whose light reflectance is high appears noticeably “shiny”.

Further, a surface 303b of the edge portion of the island of pigment ink 303 (that is, the portion where there is a sudden change in brightness) is slanted, and thus, depending on the viewing angle or the angle of incidence of the light, only that portion may noticeably appear “shiny”. This difference in light reflectance of the printed object surface, that is, the difference in the degree of luster, is assumed to be a cause of unevenness in luster in objects printed using pigment ink.

(1-A) Accordingly, unevenness in luster has been reduced by discharging ink (clear ink) that has a degree of luster equivalent to that of pigment-based ink but that does not include color material, to areas where the density of dots formed by ink including color material (hereinafter, referred to as “color ink”) is low.

(1-B) Unevenness in luster has also been reduced by discharging clear ink such as that described above to the entire image, rather than just to areas of low dot density, or in other words, so as to create a uniform overcoat over the image.

Item (2) “correcting ink bleeding, etc.” is described next. (2-A) In recent years, to achieve higher image quality, the grainy feel in images has been reduced by reducing the size of the droplets of the ejection ink so as to achieve smaller dot sizes, and the number of expressible gradations has been increased without increasing the matrix size of each pixel. If the ink bleeds on the print medium, however, there are instances where the formed dots cannot be made sufficiently small even though the size of the ink droplets has been reduced, and where the bleeding of the ink results in poorer image quality.

Further, various types of media have been employed as print media. Therefore, it may not be possible to obtain sufficient coloring, setting, or drying of the ink depending on the type of the medium, and thus satisfactory image quality cannot be obtained.

Accordingly, to prevent such problems, clear ink that is created by dissolving, in a solvent, a substance for reducing the bleeding of ink, or for improving the coloring, setting, or drying properties of the ink (hereinafter, referred to as “bleeding, etc.”) by causing a chemical change between it and the color ink is discharged to or near sections where dots of color ink are formed, thereby preventing bleeding, etc.

(2-B) Also, in recent years, print media provided with a coloring layer on their surface have been used to achieve high-quality printing having a less grainy feel to the dots. Print media provided with a coloring layer can be broadly divided into two types, namely, the so-called absorption type media and swelling type media. Absorption type media refer to media in which color is generated by the adhesion of color materials contained in the ink to pigments such as silica or alumina contained in the coloring layer. Swelling type media refer to media in which the coloring layer includes a polymer such as gelatin and in which the color is generated by the polymer getting swollen due to absorption of the ink and trapping ink within it. Many of the silica or the like that is used in absorption type media chemically bond with the color material easily, whereas many of the polymer such as gelatin do not chemically react easily with the color material, and thus, the latter features excellent light-resistance because chemical changes do not occur even when the polymer is struck by light.

Although print media provided with a coloring layer demonstrate improved image quality with respect to natural images, in which dots are formed relatively densely, in images where the dot recording rate is low, such as for ruled lines, they may exhibit a problem similar to bleeding. For example, in the case of swelling type media, when a new ink droplet is discharged before a dot has completely dried, then this results in the formation of a single large dot because the dot and the ink droplet mix since the media is in a swellable state. In contrast, ink droplets cannot be absorbed further by areas where dots have completely dried and set, and thus, subsequently discharged ink droplets form dots at locations that are peripheral to these dots and where ink can be absorbed. Thus, ruled lines and the like appear jagged. A similar problem occurs not only when ink is discharged over dots but also when ink is discharged near dots.

Accordingly, to avoid such problems, clear ink made of solvent only is discharged at or near the areas where dots are formed in order to keep the dots from drying and reduce the occurrence of bleeding of ruled lines or the like.

Lastly, item (3) “improving the printing speed” is described below.

As discussed above, although the image quality is improved when the size of the drops of ejection ink is reduced in order to improve the image quality, when performing, for example, so-called “solid printing” in which it is necessary to print an entire surface with the same color, it is necessary to print the entire surface of the print medium using ink droplets consisting of a small amount of ink, which therefore requires repeated execution of the printing operation, and this results in a drop in the printing speed.

Accordingly, diffusion of the ink is induced to make the dots that are being formed become larger than normal size by ejecting clear ink (ink made of only solvent and not including color material) adjacent to dots formed by color ink, thereby increasing the print speed.

Incidentally, it is preferable that clear ink is printed before color ink is printed in order to correct the bleeding, etc. of ink as discussed in (2-A).

It is preferable, however, that clear ink is printed after color ink has been printed to correct unevenness in luster as discussed in (1-A) and (1-B), to correct the bleeding of ink of ruled lines or the like discussed in (2-B), and to improve the printing speed discussed in (3).

The timing at which clear ink is printed has not been sufficiently considered in the past, however, and thus, there is the problem that it is not possible to print clear ink at a suitable timing.

### SUMMARY OF THE INVENTION

The present invention was arrived at in light of the foregoing issues, and it is an object thereof to provide a printing apparatus, a print head, and a printing method with which clear ink can be printed at an appropriate timing.

A primary aspect of the present invention is a printing apparatus such as the following.

A printing apparatus comprises:
a carrying mechanism for carrying a medium in a carrying direction; and
a print head having a plurality of nozzles for ejecting ink to form dots on the medium that is carried by the carrying mechanism,
wherein the print head includes:
   a first nozzle row having a plurality of nozzles that are for ejecting ink not having color material and that are arranged in the carrying direction; and
   a second nozzle row having a plurality of nozzles that are for ejecting ink having color material and that are arranged in the carrying direction, and
wherein the first nozzle row is arranged at least on one of an upstream side and a downstream side of the second nozzle row in the carrying direction.

Further, another primary aspect of the present invention is a printing apparatus such as the following.

A printing apparatus comprises:
a carrying mechanism for carrying a medium in a carrying direction; and
a print head that has a plurality of nozzles for ejecting ink to form dots on the medium carried by the carrying mechanism, and that moves in a predetermined direction to perform printing,
wherein the print head includes:
   a first nozzle row having a plurality of nozzles that are for ejecting ink not having color material and that are arranged in the carrying direction; and
   a second nozzle row having a plurality of nozzles that are for ejecting ink having color material and that are arranged in the carrying direction, and
wherein the first nozzle row is arranged at least on one of an upstream side and a downstream side of the second nozzle row in the predetermined direction.

Further, another primary aspect of the present invention is a printing apparatus such as the following.

A printing apparatus comprises:
a carrying mechanism for carrying a medium in a carrying direction; and
a print head that has a plurality of nozzles for ejecting ink to form dots on the medium carried by the carrying mechanism, and that moves in a predetermined direction and an opposite direction thereto to perform printing,
wherein the print head includes:
   a first nozzle row having a plurality of nozzles that are for ejecting ink not having color material and that are arranged in the carrying direction; and
   a second nozzle row having a plurality of nozzles that are for ejecting ink having color material and that are arranged in the carrying direction,
wherein the first nozzle row is arranged on both an upstream side and a downstream side of the second nozzle row in the predetermined direction, and
wherein during printing, the second nozzle row and either one of the first nozzle rows arranged on the upstream side and the downstream side are used to perform printing.

Further, another primary aspect of the present invention is a print head such as the following.

A print head having a plurality of nozzles for ejecting ink to form dots on a medium, comprises:
a first nozzle row having a plurality of nozzles that are for ejecting ink not having color material and that are arranged in a carrying direction in which the medium is carried; and
a second nozzle row having a plurality of nozzles that are for ejecting ink having color material and that are arranged in the carrying direction,
wherein the first nozzle row is arranged at least on one of an upstream side and a downstream side of the second nozzle row in the carrying direction.

Further, another primary aspect of the present invention is a print head such as the following.

A print head having a plurality of nozzles for ejecting ink to form dots on a medium, comprises:
a first nozzle row having a plurality of nozzles that are for ejecting ink not having color material and that are arranged in a carrying direction in which the medium is carried; and
a second nozzle row having a plurality of nozzles that are for ejecting ink having color material and that are arranged in the carrying direction,
wherein the first nozzle row is arranged at least on one of an upstream side and a downstream side of the second nozzle row in the carrying direction, and
wherein the ink not having color material is ejected from the first nozzle row before ink is ejected from the second nozzle row.

Further, another primary aspect of the present invention is a print head such as the following.

A print head having a plurality of nozzles for ejecting ink to form dots on a medium, comprises:
a first nozzle row having a plurality of nozzles that are for ejecting ink not having color material and that are arranged in a carrying direction in which the medium is carried; and
a second nozzle row having a plurality of nozzles that are for ejecting ink having color material and that are arranged in the carrying direction,
wherein the first nozzle row is arranged at least on one of an upstream side and a downstream side of the second nozzle row in the carrying direction, and
wherein the ink not having color material is ejected from the first nozzle row after ink is ejected from the second nozzle row.

Further, another primary aspect of the present invention is a printing method such as the following.

A printing method comprises:
a step of carrying a medium in a carrying direction;
a step of ejecting ink not having color material onto the medium; and
a step of ejecting ink having color material after the ink not having color material has been ejected onto the medium.

Further, another primary aspect of the present invention is a printing method such as the following.

A printing method comprises:
a step of carrying a medium in a carrying direction;
a step of ejecting ink having color material onto the medium; and
a step of ejecting ink not having color material after the ink having color material has been ejected onto the medium.

Other features of the present invention will become clear through the accompanying drawings and the following description.

### BRIEF DESCRIPTION OF THE DRAWINGS

For a more complete understanding of the present invention and the advantages thereof, reference is now made to the following description taken in conjunction with the accompanying drawings.

FIG. 1 is a diagram schematically showing a structure of a printer and a computer system for printing according to a first embodiment.

FIG. 2 is a block diagram showing a structure of primary components of the printer, focusing on a control circuit, in the computer system for printing shown in FIG. 1.

FIG. 3 is a block diagram showing a detailed structure of a computer in the computer system for printing shown in FIG. 1.

FIG. 4A is a diagram showing an arrangement of nozzles in a print head 12.

FIG. 4B is a diagram showing a positional relationship between nozzle rows R2 to R5 and a print paper P during printing.

FIG. 5 is a diagram showing functions of driver software of the computer shown in FIG. 1.

FIG. 6 is a diagram showing an example of a dot pattern that is formed on the print paper by the printer shown in FIG. 1.

FIG. 7 is a diagram showing another example of a configuration of a print head of the printer according to a second embodiment.

FIG. 8A is a diagram showing a first example of another structure of the print head.

FIG. 8B is a diagram showing a first example of another structure of the print head.

FIG. 9A is a cross sectional view of a dot formed by dye-based ink.

FIG. 9B is a cross sectional view of dots formed by pigment-based ink.

FIG. 10 is a diagram schematically showing a structure of a printer and a computer system for printing according to a third embodiment.

FIG. 11 is a block diagram showing a structure of primary components of the printer, focusing on a control circuit, in the computer system for printing shown in FIG. 10.

FIG. 12 is a block diagram showing a detailed structure of a computer in the computer system for printing shown in FIG. 10.

FIG. 13A is a diagram showing an arrangement of nozzles in a print head 1012.

FIG. 13B is a diagram showing a positional relationship between nozzle rows R2 to R5 and a print paper P during printing.

FIG. 14 is a diagram showing functions of driver software of the computer shown in FIG. 10.

FIG. 15 is a diagram showing a relationship between the amount of color ink discharged and the amount of clear ink ejected per unit area for the printer shown in FIG. 10.

FIG. 16 is a schematic view of a cross section of dots formed on the print paper by the printer shown in FIG. 10.

FIG. 17 is a diagram showing an example of a dot pattern that is formed on the print paper by the printer shown in FIG. 10.

FIG. 18 is a diagram showing an example of a configuration of a print head of the printer according to a fourth embodiment.

FIG. 19A is a diagram showing a first example of another structure of the print head.

FIG. 19B is a diagram showing a second example of another structure of the print head.

### DETAILED DESCRIPTION OF PREFERRED EMBODIMENTS

At least the following matters will be made clear by the present specification and the accompanying drawings.

A printing apparatus comprises:
a carrying mechanism for carrying a medium in a carrying direction; and
a print head having a plurality of nozzles for ejecting ink to form dots on the medium that is carried by the carrying mechanism,
wherein the print head includes:
   a first nozzle row having a plurality of nozzles that are for ejecting ink not having color material and that are arranged in the carrying direction; and
   a second nozzle row having a plurality of nozzles that are for ejecting ink having color material and that are arranged in the carrying direction, and
wherein the first nozzle row is arranged at least on one of an upstream side and a downstream side of the second nozzle row in the carrying direction.

Thus, it is possible to print with ink not having color material at a suitable timing.

Further, the first nozzle row may be arranged on the upstream side of the second nozzle row in the carrying direction.

Further, the second nozzle row may have a plurality of nozzle rows each for ejecting ink of a different color. Thus, it is possible to print with ink of different colors after ejection of ink not having color material is complete.

Further, the ink not having color material may be an ink that is preferably ejected in advance of the ink having color material. As a result, it is possible for ink not having color material to be printed in the ideal order.

Further, the ink not having color material may be an ink that chemically reacts with the ink having color material, and moreover, the ink not having color material may be an ink that is for preventing bleeding, improving coloring properties, improving setting properties, or improving drying properties. Thus, it is possible both to reliably eliminate bleeding and to improve the coloring, setting, and drying properties.

Further, the first nozzle row may be arranged on the downstream side of the second nozzle row in the carrying direction.

In this case also, the second nozzle row may have a plurality of nozzle rows each for ejecting ink of a different color. Thus, it is possible for ink not having color material to be ejected after the ejection of ink of different colors is complete.

Further, the ink not having color material may be an ink that is preferably printed after the ink having color material. As a result, it is possible for ink not having color material to be printed in the ideal order.

Further, the ink not having color material may be an ink that is for preventing bleeding, improving coloring properties, improving setting properties, or improving drying properties. Thus, it is possible to reliably eliminate bleeding and unevenness in luster as well as increase the printing speed.

Further, the first nozzle row may be arranged on the upstream side and on the downstream side of the second nozzle row in the carrying direction, and the ink not having color material may be suitably ejected from these first nozzle rows.

Further, a printing apparatus comprises:
a carrying mechanism for carrying a medium in a carrying direction; and
a print head that has a plurality of nozzles for ejecting ink to form dots on the medium carried by the carrying mechanism, and that moves in a predetermined direction to perform printing,
wherein the print head includes:
   a first nozzle row having a plurality of nozzles that are for ejecting ink not having color material and that are arranged in the carrying direction; and
   a second nozzle row having a plurality of nozzles that are for ejecting ink having color material and that are arranged in the carrying direction, and
wherein the first nozzle row is arranged at least on one of an upstream side and a downstream side of the second nozzle row in the predetermined direction.

Thus, it is possible to print with ink not having color material at a preferable timing. Further, the first nozzle row may be arranged on the downstream side of the second nozzle row in the predetermined direction, the first nozzle row may be arranged on the upstream side of the second nozzle row in the predetermined direction, or the first nozzle row may be arranged on the upstream side and on the downstream side of the second nozzle row in the predetermined direction and the ink not having color material may be suitably ejected from these first nozzle rows. Thus, it becomes possible to print with ink not having color material in an ideal order without complicating control within the printer.

Further, a printing apparatus comprises:
a carrying mechanism for carrying a medium in a carrying direction; and
a print head that has a plurality of nozzles for ejecting ink to form dots on the medium carried by the carrying mechanism, and that moves in a predetermined direction and an opposite direction thereto to perform printing,
wherein the print head includes:
   a first nozzle row having a plurality of nozzles that are for ejecting ink not having color material and that are arranged in the carrying direction; and
   a second nozzle row having a plurality of nozzles that are for ejecting ink having color material and that are arranged in the carrying direction,
wherein the first nozzle row is arranged on both an upstream side and a downstream side of the second nozzle row in the predetermined direction, and
wherein during printing, the second nozzle row and either one of the first nozzle rows arranged on the upstream side and the downstream side are used to perform printing.

Thus, it is possible to print with ink not having color material at a preferable timing.

Further, during printing, the second nozzle row and the first nozzle row, of the first nozzle rows arranged on the upstream side and the downstream side, that is positioned on a front side in the direction in which the print head moves may be used to perform printing. Thus, in the printer, the ink not having color material is printed in the ideal order, and it becomes possible to increase the printing speed.

Further, during printing, the second nozzle row and the first nozzle row, of the first nozzle rows arranged on the upstream side and the downstream side, that is positioned on a rear side in the direction in which the print head moves may be used to perform printing. Thus, in the printer, the ink not having color material is printed in the ideal order, and it becomes possible to increase the printing speed.

Further, a print head having a plurality of nozzles for ejecting ink to form dots on a medium comprises:
a first nozzle row having a plurality of nozzles that are for ejecting ink not having color material and that are arranged in a carrying direction in which the medium is carried; and
a second nozzle row having a plurality of nozzles that are for ejecting ink having color material and that are arranged in the carrying direction,
wherein the first nozzle row is arranged at least on one of an upstream side and a downstream side of the second nozzle row in the carrying direction.

Thus, it is possible to print with ink not having color material at a preferable timing.

Further, the first nozzle row may be arranged on the upstream side of the second nozzle row in the carrying direction, the first nozzle row may be arranged on the downstream side of the second nozzle row in the carrying direction, or the first nozzle row may be arranged on the upstream side of the second nozzle row in the carrying direction and on the downstream side of the second nozzle row in the carrying direction and the ink not having color material may be suitably ejected from these first nozzle rows.

Further, a print head having a plurality of nozzles for ejecting ink to form dots on a medium comprises:
a first nozzle row having a plurality of nozzles that are for ejecting ink not having color material and that are arranged in a carrying direction in which the medium is carried; and
a second nozzle row having a plurality of nozzles that are for ejecting ink having color material and that are arranged in the carrying direction,
wherein the first nozzle row is arranged at least on one of an upstream side and a downstream side of the second nozzle row in the carrying direction, and the ink not having color material is ejected from the first nozzle row before ink is ejected from the second nozzle row.

Thus, with the print head, it is possible to print with the ink not having color material at a preferable timing, where necessary.

A print head having a plurality of nozzles for ejecting ink to form dots on a medium, comprises:
a first nozzle row having a plurality of nozzles that are for ejecting ink not having color material and that are arranged in a carrying direction in which the medium is carried; and
a second nozzle row having a plurality of nozzles that are for ejecting ink having color material and that are arranged in the carrying direction,
wherein the first nozzle row is arranged at least on one of an upstream side and a downstream side of the second nozzle row in the carrying direction, and the ink not having color material is ejected from the first nozzle row after ink is ejected from the second nozzle row.

Such a print head also allows the ink not having color material to be printed at a preferable timing, where necessary.

It is also possible to achieve a printing method such as the following.

A printing method comprises:
a step of carrying a medium in a carrying direction;
a step of ejecting ink not having color material onto the medium; and
a step of ejecting ink having color material after the ink not having color material has been ejected onto the medium.

A printing method comprises:
a step of carrying a medium in a carrying direction;
a step of ejecting ink having color material onto the medium; and
a step of ejecting ink not having color material after the ink having color material has been ejected onto the medium.

### First Embodiment

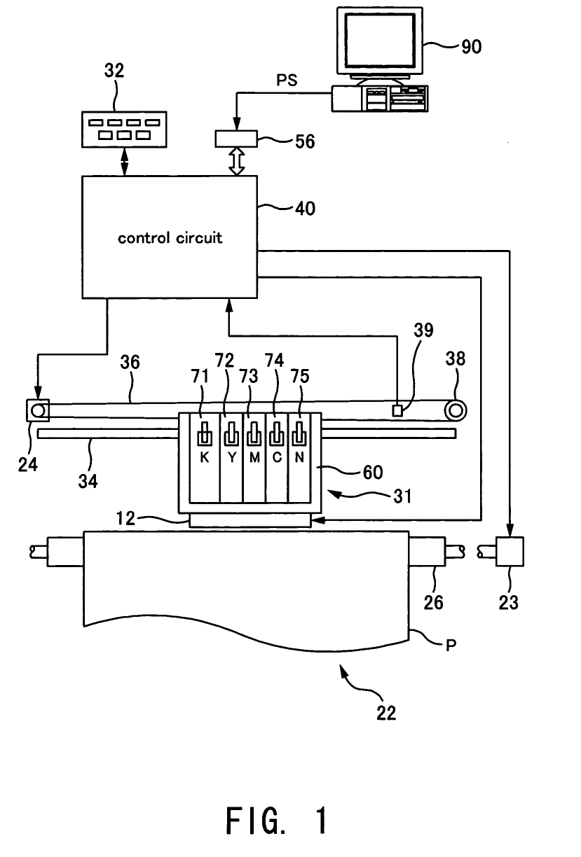

First, a first embodiment is described with reference to FIG. 1 to FIG. 8B.

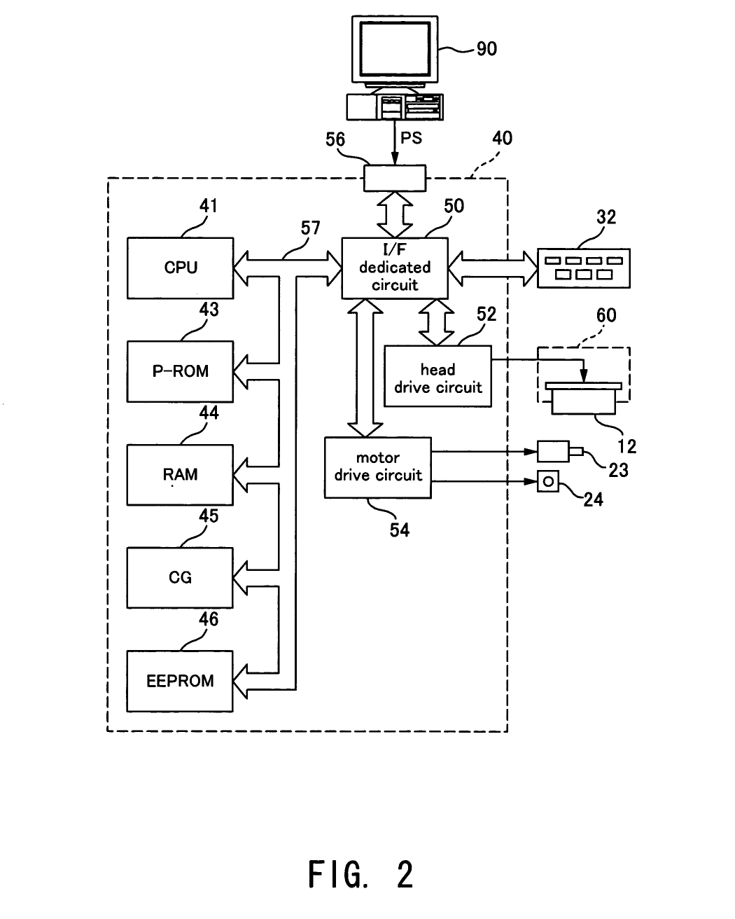

First, an overview of a printing apparatus and a computer system for printing is provided with reference to FIG. 1 and FIG. 2. FIG. 1 is a structural diagram that schematically shows a computer system for printing provided with an inkjet printer (hereinafter, abbreviated to “printer”) 22, which is a printing apparatus. FIG. 2 is a block diagram showing an example of a structure of primary components of the printer 22, focusing on a control circuit 40.

As shown in FIG. 1, the printer 22 has a sub-scan feed mechanism serving as a carry mechanism for carrying a print paper P in a carrying direction using a paper feed motor 23, and a main-scan feed mechanism for moving a carriage 31 back and forth in the axial direction of a paper feed roller 26 using a carriage motor 24. Here, the direction in which the print paper P is fed by the sub-scan feed mechanism is referred to as the sub-scanning direction, and the direction in which the carriage 31 is moved by the main-scan feed mechanism is referred to as the main-scanning direction.

The printer 22 is also provided with a print head unit 60, which is mounted to the carriage 31 and provided with a print head 12, a head drive mechanism for driving the print head unit 60 to control the ejection of ink and dot formation, and the control circuit 40 for sending and receiving signals to and from the paper feed motor 23, the carriage motor 24, the print head unit 60, and a control panel 32.

The control circuit 40 is connected to a computer 90 via a connector 56. The computer 90 is provided with a driver for the printer 22, and functions as a user interface for receiving commands made by a user operating an input device such as a keyboard or a mouse, and for displaying various types of information in the printer 22 through a screen display of a display device.

The sub-scan feed mechanism for carrying the print paper P is provided with a gear train (not shown) that transmits the rotation of the paper feed motor 23 to the paper feed roller 26 and a paper carry roller (not shown).

Further, the main-scan feed mechanism for moving the carriage 31 back and forth is provided with a slide shaft 34 which is provided parallel to the shaft of the paper feed roller 26 and which slidably retains the carriage 31, a pulley 38, wherein an endless drive belt 36 is provided spanning between the pulley 38 and the carriage motor 24, and a position detection sensor 39 for detecting the position of origin of the carriage 31.

As shown in FIG. 2, the control circuit 40 is constituted as an arithmetic and logic circuit that is provided with a CPU (Central Processing Unit) 41, a programmable ROM (P-ROM (Read Only Memory)) 43, a RAM (Random Access Memory) 44, a character generator (CG) 45 storing character dot matrix, and an EEPROM (Electronically Erasable and Programmable ROM) 46.

The control circuit 40 is further provided with an I/F dedicated circuit 50, which is an interface (I/F) with respect to external motors etc., a head drive circuit 52 connected to the I/F dedicated circuit 50 for driving the print head unit 60 and causing it to eject ink, and a motor drive circuit 54 for driving the paper feed motor 23 and the carriage motor 24.

The I/F dedicated circuit 50 is internally provided with a parallel interface circuit, and via the connector 56, it is capable of receiving print signals PS that are supplied from the computer 90.

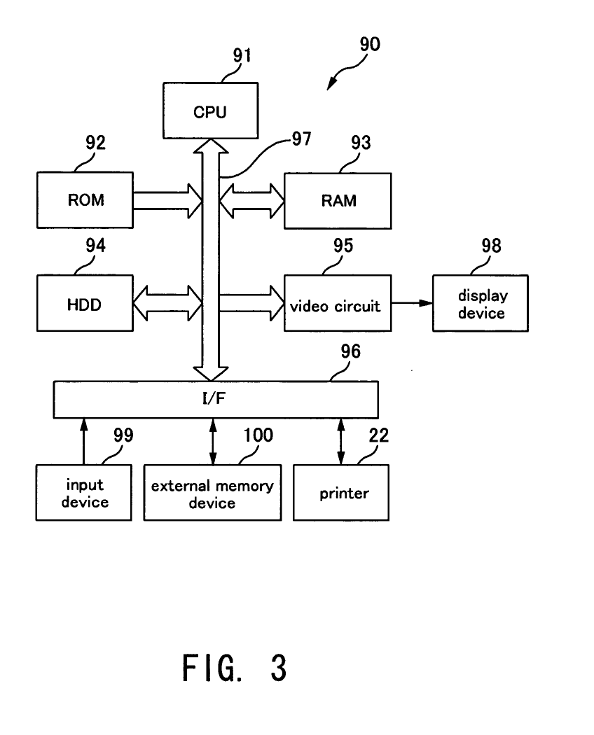

The configuration of the computer 90 is described next with reference to FIG. 3.

As shown in FIG. 3, the computer 90 is constituted by a CPU 91, a ROM 92, a RAM 93, an HDD (Hard DiskDrive) 94, a video circuit 95, an I/F 96, a bus 97, a display device 98, an input device 99, and an external memory device 100.

Here, the CPU 91 is a controller for executing various computing processes in accordance with programs stored in the ROM 92 or the HDD 94, and for controlling the various sections of the apparatus.

The ROM 92 is a memory storing data and basic programs executed by the CPU 91. The RAM 93 is a memory for temporarily storing, for example, programs being executed by the CPU 91 and data being computed.

The HDD 94 is a storage device for reading out data or programs stored on a hard disk, which is a storage medium, in accordance with requests from the CPU 91, and for storing, on the hard disk, data generated as the outcome of computer processing by the CPU 91.

The video circuit 95 is a circuit for executing drawing processing in accordance with draw commands supplied from the CPU 91 to convert obtained image data into a video signal, and outputting this signal to the display device 98.

The I/F 96 is a circuit for suitably converting the expression format of signals that are output from the input device 99 and the external memory device 100 and outputting a print signal PS to the printer 22.

The bus 97 is a signal line that connects the CPU 91, the ROM 92, the RAM 93, the HDD 94, the video circuit 95, and the I/F 96 to one another, allowing data to be sent and received between them.

The display device 98 is a device that is constituted of, for example, an LCD (Liquid Crystal Display) monitor or a CRT (Cathode Ray Tube) monitor, and that displays images corresponding to video signals output from the video circuit 95.

The input device 99 is a device that is constituted of, for example, a keyboard and a mouse, and that is for generating signals corresponding to operations performed by a user and supplying these to the I/F 96.

The external memory device 100 is a device that is constituted of, for example, a CD-ROM (Compact Disk-ROM) drive unit, an MO (Magneto Optic) drive unit, or an FDD (Flexible Disk Drive) unit, and that is for reading data and programs stored on CD-ROM disks, MO disks, or FDs and supplying these to the CPU 91. If the external memory device 100 is an MO drive unit or an FDD unit, then it also functions as a device for storing data supplied from the CPU 91 on an MO disk or an FD.

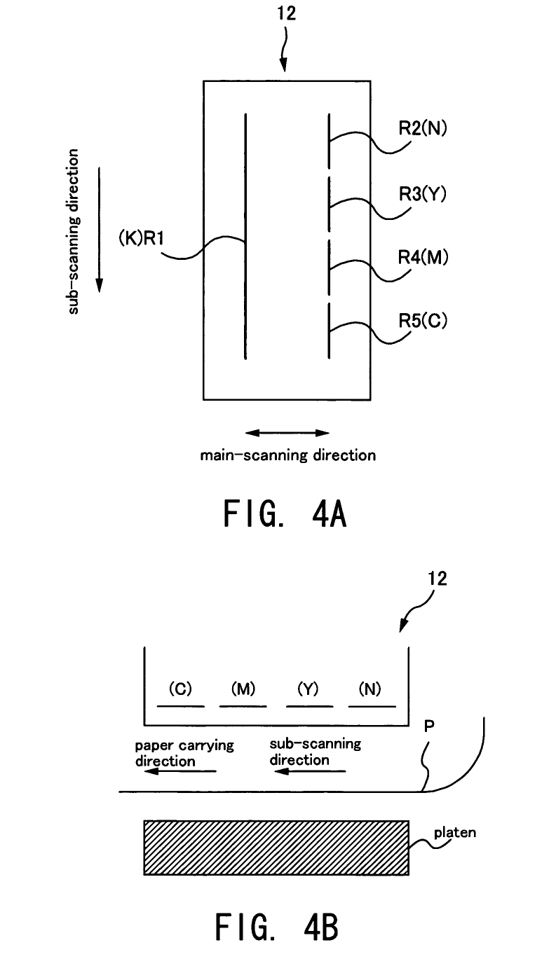

The configuration of the print head 12 is described next with reference to FIG. 1, FIG. 4A, and FIG. 4B.

As shown in FIG. 1, five ink cartridges 71 and 75, namely, a cartridge 71 containing black (K) ink, a cartridge 72 containing yellow (Y) ink, a cartridge 73 containing magenta (M) ink, a cartridge 74 containing cyan (C) ink, and a cartridge 75 containing clear (N) ink, are removably mounted to the carriage 31. It should be noted that the composition of the clear ink and the color inks differs according to the application thereof, and thus is described in detail later.

As shown in FIG. 1, the print head 12 is provided at a lower section of the carriage 31. As shown in FIG. 4A, nozzle rows R1 to R5 in which nozzles, functioning as ink ejection locations, are arranged in rows in the direction in which the print paper P is carried are formed in the print head 12. It should be noted that the configuration of the nozzles is described in detail later.

Piezoelectric elements, which are a type of electrostrictive element with excellent responsiveness, are provided at a lower section of the carriage 31 and arranged for each nozzle in the nozzle rows R1 to R5, which correspond to each type of ink. The piezoelectric elements are arranged at positions in contact with members forming the ink paths over which ink is guided to the nozzles. When voltage is applied the piezoelectric elements, their crystalline structure is deformed, and thus, they convert the electrical energy to mechanical energy very quickly.

In the first embodiment, voltage of a predetermined duration is applied between electrodes provided on both sides of each piezoelectric element, and thus, the piezoelectric elements expand during application of the voltage and deform one lateral wall of the ink path. As a result, the volume of the ink path is constricted by an amount according to the expansion of the piezoelectric element, and ink corresponding to this amount of constriction is quickly ejected from the tip of a nozzle as an ink droplet. The ink droplet soaks into the print paper P, which is guided along the paper feed roller 26, thereby forming a dot to carry out printing.

FIG. 4A is a diagram showing an arrangement of the nozzles in the print head 12 (with the nozzles 12 viewed from the perspective of the print paper P). As shown in the figure, the nozzle row R1 for ejecting black (K) ink is formed on the left side of the print head 12, and the nozzle rows R2 to R5 for ejecting clear (N), yellow (Y), magenta (M), and cyan (C) ink are formed in that order in a row in the sub-operation direction. It should be noted that the nozzle row R2 serves as the first nozzle row, and the nozzle rows R3 to R5 serve as the second nozzle row.

FIG. 4B is a diagram showing a positional relationship between the nozzle rows R2 to R5 and the print paper P during printing. As shown in the figure, the print paper P is carried from right to left in the diagram between the print head 12 and a platen (a member which is arranged in a position that is in opposition to the print head 12 and which supports the print paper P such that it is flat), and droplets of ink are discharged from the nozzle rows R2 to R5 of the print head 12 in that order (the order of NYMC). It is clear from FIG. 4A that the clear (N) ink is arranged on the most upstream side in the sub-scanning direction, that is, the front end side in the sub-scanning direction, of the print paper P, and thus, the clear (N) ink is discharged first.

Here, the nozzle rows R1 to R5 are expressed as single line segments in FIG. 4A, but in practice, each line segment is constituted by a plurality of nozzles arranged in a row. It should be noted that instead of the arrangement shown in FIG. 4A, an arrangement in which the nozzle row R1 and the nozzle rows R2 to R5 are left-right inversed is also possible. Further, although it is necessary for the nozzle row R2 to be upstream of the nozzle rows R3 to R5, the order in which the nozzle rows R3 to R4 are arranged can be different from the order shown in FIG. 4A.

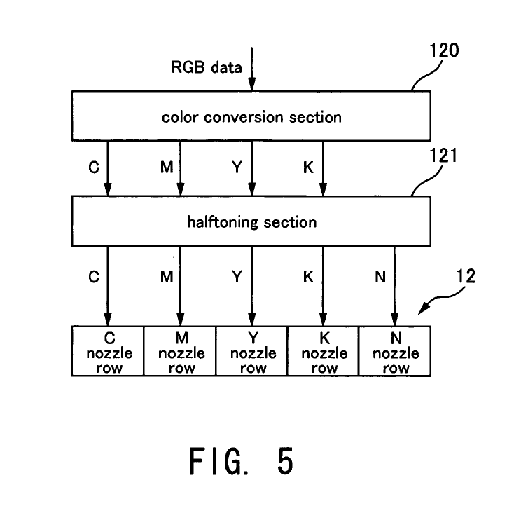

FIG. 5 is a diagram showing functional blocks of the driver software for the printer 22 that is installed in the computer 90. As shown in the diagram, the driver software is constituted of a color conversion section 120 and a halftoning section 121, and the output of the halftoning section 121 is supplied to the nozzle rows.

Here, the color conversion section 120 receives the input of image data such as RGB (Red, Green, Blue) full color image data and converts color data, which constitutes the input image data and which is expressed in the RGB color system, into color data in the CMY color system, which has color components corresponding to the set of color inks. It should be noted that black (K) is used when printing text, for example, and is not used for color printing.

The halftoning section 121 executes processing such as error diffusion or dithering with respect to image data output from the color conversion section 120, thereby converting data of multiple gradations (for example, 256 tones) of the CMY colors into binarized bitmap data, for example, expressed by the density of the dots of the CMY colors. Further, when printing text, the character data is subjected to error diffusion and converted into binarized bitmap data for K.

Further, the halftoning section 121, when creating bitmap data in the case of color printing, creates N dot data indicating the dots of clear ink in addition to the CMY dot data indicating the dots of CMY. For example, in the case of (1-A)—correcting unevenness in luster—discussed above, the N dot data is set such that, considering a single or a plurality of pixels, clear ink is discharged in a supplementary manner such that the amount of discharged color ink in those dots or dot groups is within a predetermined range. It should be noted that the bitmap data output from the halftoning section 121 includes the C, M, Y, K, and N bitmap data mentioned above.

The bitmap data output from the halftoning section 121 are supplied to the print head 12, and droplets of C, M, Y, and N ink are ejected according to the bitmap data when printing an image, whereas droplets of K ink are ejected when printing text, thus forming dots on the print paper P.

Next, the operation of the first embodiment is described, taking as an example the case of (2-A) mentioned above, that is, a case where clear ink is discharged in beforehand to or near areas where dots of color ink are formed, before those dots are formed, in order to prevent bleeding, etc.

In the case of (2-A), ink obtained by dissolving a transparent polymer in water, which is a solvent, is employed as the clear ink, and inks obtained by dissolving pigments of the respective colors in water, which is a solvent, are employed as the color inks.

When the input device 99 of the computer 90 is operated to request activation of the application program, the CPU 91 reads out that program from the HDD 94 and executes it. As a result, the application program is activated and it becomes possible to create or edit image data.

When a request to print a created image is made via the input device 99 after an image has been drawn or edited using this application program, the CPU 91 supplies the created image data to the driver software. It should be noted that the image data are data expressed in the RGB color system, and for example, the resolution in the height and width direction of the image data is 360 dpi (Dots Per Inch).

The color conversion section 120 of the driver software converts the image data that are received from the application program into image data expressed in the CMY color system. It should be noted that it employs, for example, an LUT (Look Up Table) stored in the HDD 94 for this conversion process.

When conversion to the CMY color system has finished, the color conversion section 120 executes error diffusion processing or dithering with respect to the image data (256-tone data) expressed in the CMY color system obtained as a result of the conversion, thus creating binarized bitmap data for each CMY color. It should be noted that at this time, the resolution of the image at this time is converted from the resolution of 360×360 dpi in height and width for when it was input into 720×720 dpi in height and width, which corresponds to the resolution of the print head 12.

The halftoning section 121 then discharges clear ink (sets the bitmap data to “1”) in advance if, for example, either one of the pixels of color ink that are adjacent to the pixel of clear ink in the height direction (sub-scanning direction) is “1,” that is, if ink of any of the CMY colors is to be discharged. On the other hand, clear ink is not discharged (the bitmap data is set to “0”) if both adjacent color ink pixels are “0,” that is, if no color of CMY is to be discharged.

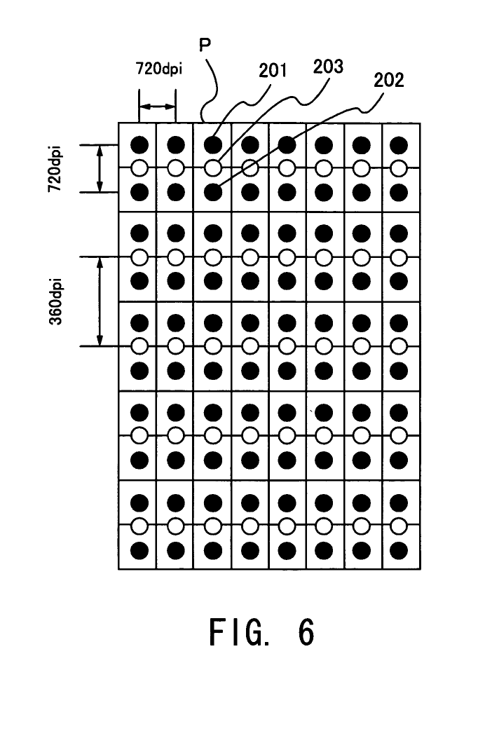

More specifically, if, as shown in FIG. 6, the resolution of the color ink is 720 dpi both in the height and width directions and the resolution of the clear ink is 360 dpi in the height direction and 720 dpi in the width direction, then a dot 203 of clear ink (shown by a white circle in FIG. 6) is set to “1” when at least one of the dots 201 and 202 (shown by black circles in FIG. 6) corresponding to the color ink is “1,” and when both of these are “0,” the dot 203 corresponding to the clear ink is set to “0.”

The bitmap data of the color ink and the clear ink created in this manner are output from the halftoning section 121 and supplied to the printer 22 via the I/F section 96. The CPU 41 in the printer 22 receives these data. The CPU 41 drives the paper feed motor 23 to draw out a single sheet of print paper P and send the paper to the print start position. Then, when the print start position of the print paper P has been moved to directly below the print head 12, the bitmap data that have been received are supplied to the print head 12 via the head drive circuit 52 and printing is started. At this time, the bitmap data of the clear ink is supplied to the nozzle row R2 of the print head 12, and the other bitmap data are respectively supplied to the nozzle rows R3 to R5 for each color.

When printing is started, the CPU 41 repeatedly performs the operation of scanning the carriage 31 in the main scanning direction while ejecting clear ink from the nozzle row R2 and color ink from the nozzle rows R3 to R5 and intermittently carrying the print paper P in the sub-scanning direction. At this time, first, clear (N) ink is discharged to the print paper P, and then the color ink is discharged in the order of Y, M, C, and thus the color layers are superposed. As a result, the color ink is discharged after the properties of the print paper P have been corrected through the discharge of clear ink, and thus, it becomes possible to prevent bleeding as well as achieve an improvement in the coloring properties, setting properties, or drying properties.

As illustrated above, in the present embodiment, clear ink is discharged in advance onto regions where color ink is discharged, and thus it becomes possible to prevent bleeding and achieve an improvement in the coloring, the setting, or the drying properties of those areas. Further, since the nozzle row R2 is arranged on the most upstream side of the print head 12, the color ink is printed after the clear ink has sufficiently set and the properties of the print paper P have been improved, and thus, the effect brought about by clear ink can be adequately attained.

It should be noted that in the first embodiment discussed above, clear ink is discharged if either one of the vertically-adjacent dots of color ink (in the sub-scanning direction) has been discharged. However, apart from this, it is also possible for clear ink to be discharged to regions where the density of discharged color ink is high, or for the clear ink to be uniformly discharged to all regions.

### Second Embodiment

A second embodiment of the present invention is described next. The only difference between the second embodiment and the first embodiment is that the configuration of a print head 12A differs from that of the print head 12, and therefore, the following description addresses only the configuration of the print head 12A.

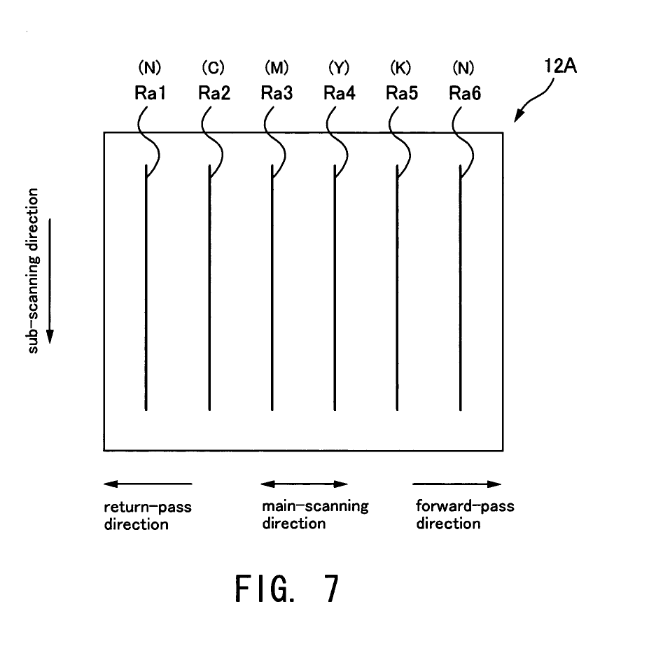

FIG. 7 is a diagram showing an example of a configuration of the print head 12A according to another embodiment of the present invention. As shown in the diagram, in this embodiment, the nozzle rows Ra1 to Ra6 are arranged next to one another in the main-scanning direction. More specifically, the nozzle rows Ra1 to Ra6 are arranged from left to right in FIG. 7, and the nozzle rows Ra1 and Ra6 are for clear (N) ink and the nozzle rows Ra2 to Ra5 are for cyan (C), magenta (M), yellow (Y), and black (K) ink, respectively. Further, in this embodiment, printing is carried out both in the forward pass and in the return pass when the print head 12A is moved back and forth in the main-scanning direction. It should be noted that the nozzle rows Ra2 to Ra5 serve as second nozzle rows, and the nozzle rows Ra1 and Ra6 serve as first nozzle rows.

The operation of the above-mentioned second embodiment is described next.

In the second embodiment, the operation of the color conversion section 120 and the halftoning section 121 shown in FIG. 5 is the same as that of the preceding embodiment, but the procedure according to which ink is ejected by the print head 12A is different. Accordingly, the operation by which ink is ejected by the print head 12A is described below taking the case of (2-A) as an example.

In the case of (2-A), bitmap data for the clear ink and the color ink are created according to the same processing as described above and supplied to the printer 22. The printer 22 supplies the bitmap data that are received from the computer 90 to the nozzle rows Ra2 to Ra5 for each color and drives the carriage motor 24 so as to carry out the printing process.

More specifically, when moving (scanning) the carriage 31 in the forward-pass direction as shown in FIG. 7, printing is carried out using nozzle rows Ra2 to Ra6 only, without using the nozzle row Ra1. That is, in printing in the forward-pass direction, printing is carried out by first printing with clear ink using the nozzle row Ra6 and then ejecting color ink from the nozzle rows Ra5, Ra4, Ra3, and Ra2, in that order, to the areas to which clear ink has been discharged.

On the other hand, in the return pass, printing is carried out using nozzle rows Ra1 to Ra5 only, without using the nozzle row Ra6. That is, in printing in the return-pass direction, printing is carried out by first discharging clear ink from the nozzle row Ra1 and then ejecting color ink from the nozzle rows Ra2, Ra3, Ra4, and Ra5, in that order.

Color ink and clear ink are applied to the print paper by repeating this forward and back operation, thus completing the printing of an image.

According to the above-mentioned second embodiment, clear ink is printed using the nozzle row Ra6 in the forward pass and is printed using the nozzle row Ra1 in the return pass, and in this way, clear ink can be printed in advance of the color ink.

Therefore, it is possible to carry out printing with color ink after the clear ink has sufficiently set on the print paper P, and thus the coloring properties etc. can be improved.

It should be noted that the above-mentioned second embodiment was described using an example in which printing is carried out both in the forward and return passes of the carriage 31, but the present invention is also applicable to printers that print, for example, only in one direction of either the forward pass or the return pass. For example, if printing is carried out only in the forward pass, then it is possible to adopt a configuration in which the nozzle row Ra1 is not provided and printing is carried out using the nozzle rows Ra2 to Ra6 only, such that color ink is printed by the nozzle rows Ra2 to Ra5 after printing of the clear ink by the nozzle row Ra6 has finished. Alternatively, if printing is carried out only in the return pass, then it is possible to adopt a configuration in which the nozzle row Ra6 is not provided and printing is carried out using the nozzle rows Ra1 to Ra5 only, such that color ink is printed by the nozzle rows Ra2 to Ra5 after printing of the clear ink by the nozzle row Ra1 has finished.

First and second embodiments of the present invention have been described above, but the present invention can take on various forms other than the above. For example, the four colors CMYK were used as inks, but it is also possible to use light color inks (light cyan (LC), light magenta (LM), dark yellow (DY)) in addition to these colors.

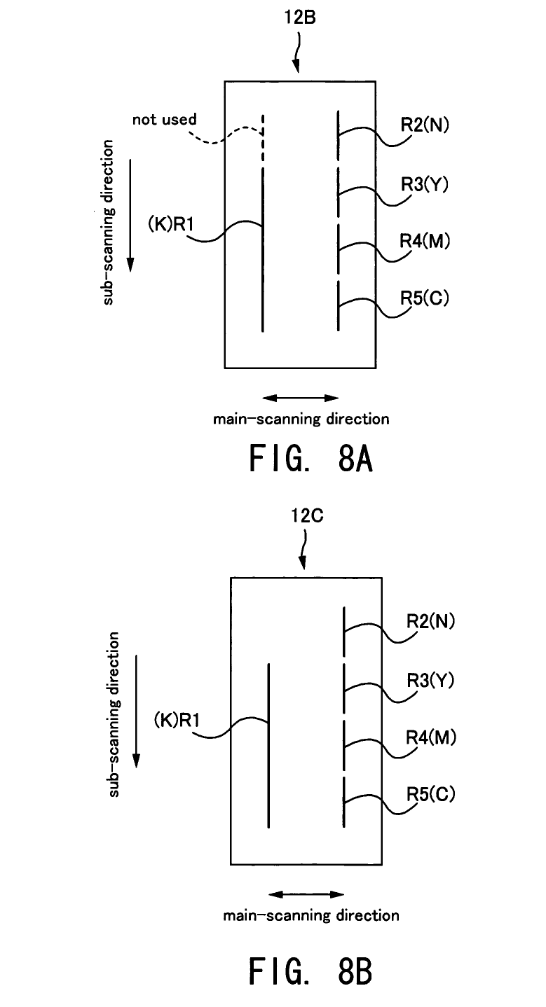

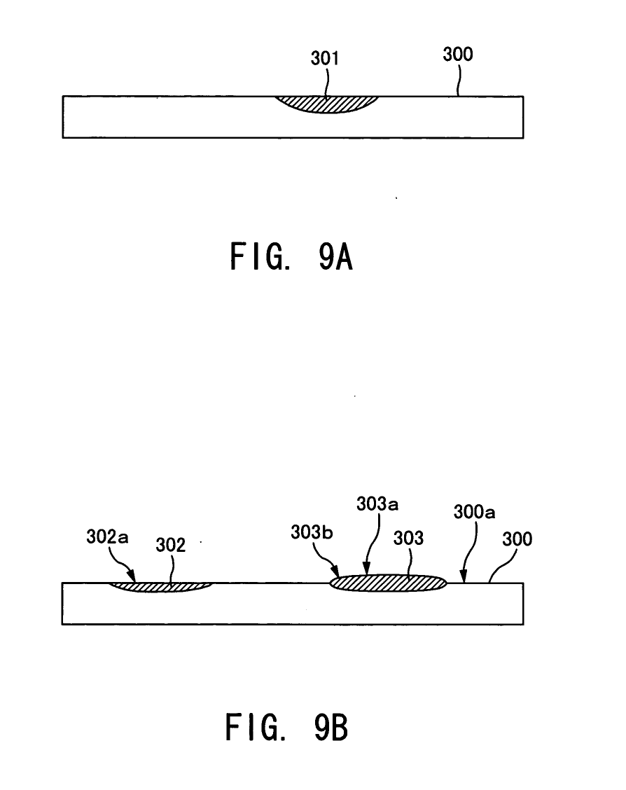

Further, in the first and second embodiments above, the three colors CMY were used when printing images, but as mentioned above, it is also possible to use light color inks and also use black (K) ink. It should be noted that in this case, if a configuration in which the nozzles are arranged in the same manner as in the embodiment shown in FIG. 4A is adopted, then, as with the print head 12B shown in FIG. 8A, printing may be performed such that, as regards the nozzle row R1, only the nozzle group within the range corresponding to the nozzle rows R2 to R4 is used, and the nozzle group within the range corresponding to the nozzle row R5 is not used, thereby allowing clear ink to be discharged after black (K) ink has been discharged. Further, as with the print head 12C shown in FIG. 8B, it is also possible not to provide the nozzle group of the nozzle row R1 within the range corresponding to the nozzle row R5 in the print head 12.

Further, specific examples were provided also for the composition of the ink, but the present invention is not limited to the specific examples that have been provided.

Further, a printer 22 provided with a head that ejects ink using piezoelectric elements is employed as discussed above, but it also possible to employ various ejection drive elements other than piezoelectric elements. For example, the present invention is also applicable to printers provided with ejection drive elements of a type that eject ink by means of bubbles generated within the ink path by passing a current through a heater arranged in the ink path.

Furthermore, in the first and second embodiments above, the processing of the color conversion section 120 and the halftoning section 121 was executed by driver software stored in the HDD 94 (or the external memory device 100). However, it is also possible to store a program having equivalent functions on the P-ROM 43 of the printer 22 and to execute the processing of the color conversion section 120 and the halftoning section 121 using this program, or to carry out processing by sharing the processes between the driver software and the printer 22.

### Third Embodiment

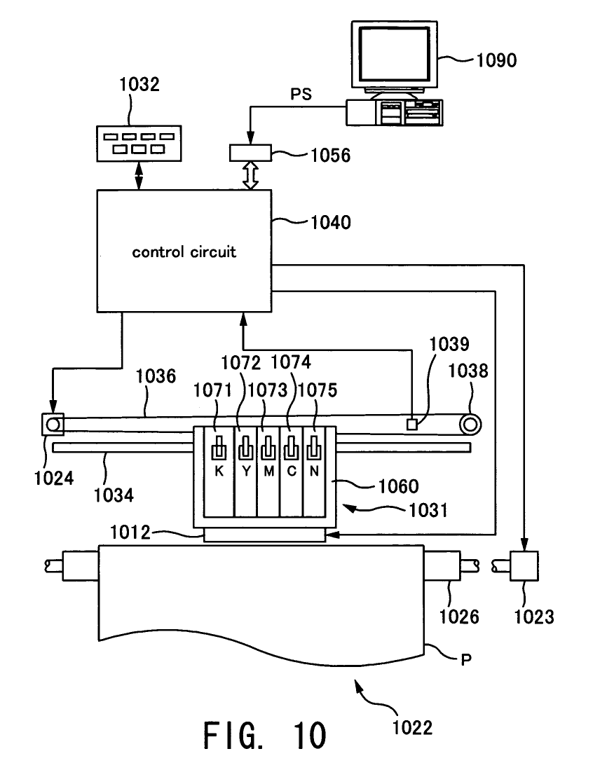

A third embodiment of the present invention is described below with reference to the drawings. First, the third embodiment is described with reference to FIG. 10 to FIG. 17.

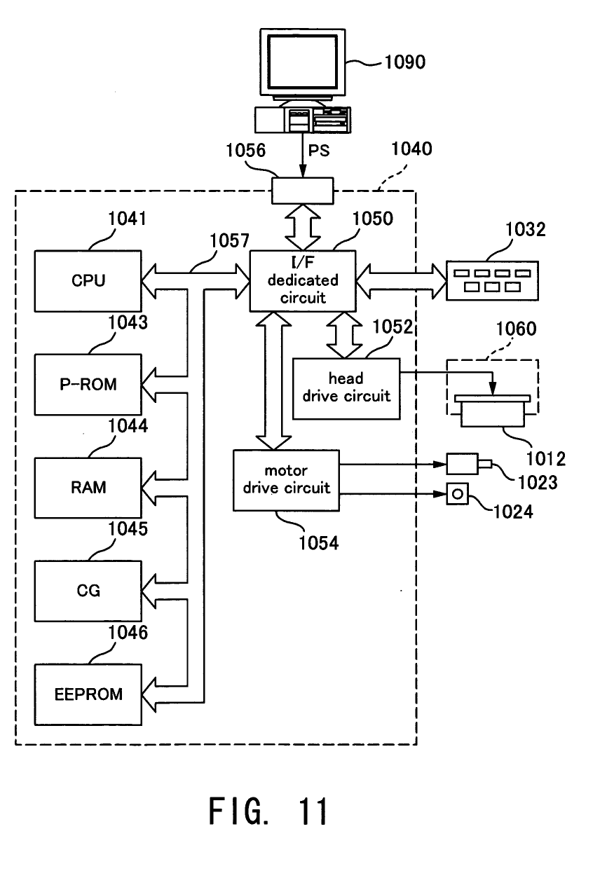

First, an overview of a printing apparatus and a computer system for printing is provided with reference to FIG. 10 and FIG. 11. FIG. 10 is a structural diagram that schematically shows a computer system for printing provided with an inkjet printer (hereinafter, abbreviated to “printer”) 1022, which is a printing apparatus. FIG. 11 is a block diagram showing an example of a structure of primary components of the printer 1022, focusing on a control circuit 1040.

As shown in FIG. 10, the printer 1022 has a sub-scan feed mechanism serving as a carry mechanism for carrying a print paper P in a carrying direction using a paper feed motor 1023, and a main-scan feed mechanism for moving a carriage 1031 back and forth in the axial direction of a paper feed roller 1026 using a carriage motor 1024. Here, the direction in which the print paper P is fed by the sub-scan feed mechanism is referred to as the sub-scanning direction, and the direction in which the carriage 1031 is moved by the main-scan feed mechanism is referred to as the main-scanning direction.

The printer 1022 is also provided with a print head unit 1060, which is mounted to the carriage 1031 and provided with a print head 1012, a head drive mechanism for driving the print head unit 1060 to control the ejection of ink and dot formation, and the control circuit 1040 for sending and receiving signals to and from the paper feed motor 1023, the carriage motor 1024, the print head unit 1060, and a control panel 1032.

The control circuit 1040 is connected to a computer 1090 via a connector 1056.

The computer 1090 is provided with a driver for the printer 1022, and functions as a user interface for receiving commands made by a user operating an input device such as a keyboard or a mouse, and for displaying various types of information in the printer 1022 through a screen display of a display device.

The sub-scan feed mechanism for carrying the print paper P is provided with a gear train (not shown) that transmits the rotation of the paper feed motor 1023 to the paper feed roller 1026 and a paper carry roller (not shown).

Further, the main-scan feed mechanism for moving the carriage 1031 back and forth is provided with a slide shaft 1034 which is provided parallel to the shaft of the paper feed roller 1026 and which slidably retains the carriage 1031, a pulley 1038, wherein an endless drive belt 1036 is provided spanning between the pulley 1038 and the carriage motor 1024, and a position detection sensor 1039 for detecting the position of origin of the carriage 1031.

As shown in FIG. 11, the control circuit 1040 is constituted as an arithmetic and logic circuit that is provided with a CPU (Central Processing Unit) 1041, a programmable ROM (P-ROM (Read Only Memory)) 1043, a RAM (Random Access Memory) 1044, a character generator (CG) 1045 storing character dot matrix, and an EEPROM (Electronically Erasable and Programmable ROM) 1046.

The control circuit 1040 is further provided with an I/F dedicated circuit 1050, which is an interface (I/F) with respect to external motors etc., a head drive circuit 1052 connected to the I/F dedicated circuit 1050 for driving the print head unit 1060 and causing it to eject ink, and a motor drive circuit 1054 for driving the paper feed motor 1023 and the carriage motor 1024.

The I/F dedicated circuit 1050 is internally provided with a parallel interface circuit, and via the connector 1056, it is capable of receiving print signals PS that are supplied from the computer 1090.

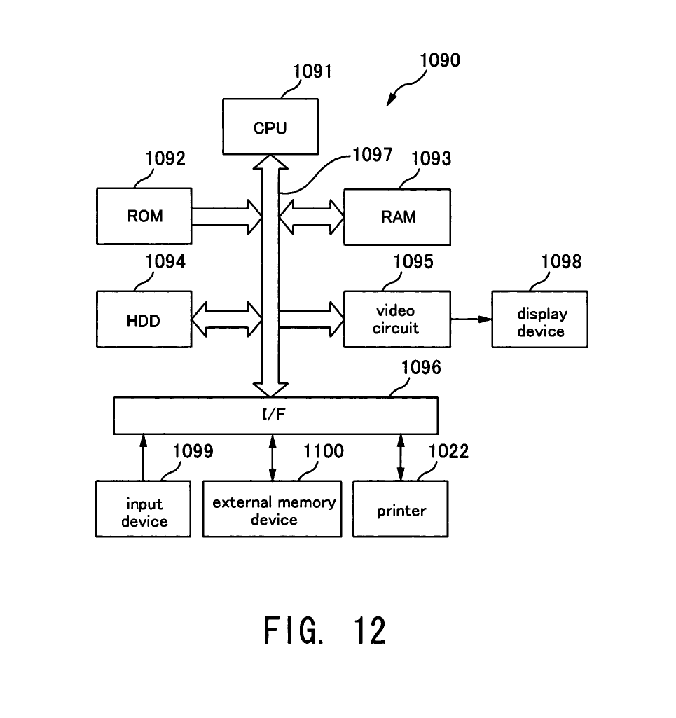

The configuration of the computer 1090 is described next with reference to FIG. 12.

As shown in FIG. 12, the computer 1090 is constituted by a CPU 1091, a ROM 1092, a RAM 1093, an HDD (Hard Disk Drive) 1094, a video circuit 1095, an I/F 1096, a bus 1097, a display device 1098, an input device 1099, and an external memory device 1100.

Here, the CPU 1091 is a controller for executing various computing processes in accordance with programs stored in the ROM 1092 or the HDD 1094, and for controlling the various sections of the apparatus.

The ROM 1092 is a memory storing data and basic programs executed by the CPU 1091. The RAM 1093 is a memory for temporarily storing, for example, programs being executed by the CPU 1091 and data being computed.

The HDD 1094 is a storage device for reading out data or programs stored on a hard disk, which is a storage medium, in accordance with requests from the CPU 1091, and for storing, on the hard disk, data generated as the outcome of computer processing by the CPU 1091.

The video circuit 1095 is a circuit for executing drawing processing in accordance with draw commands supplied from the CPU 1091 to convert obtained image data into a video signal, and outputting this signal to the display device 1098.

The I/F 1096 is a circuit for suitably converting the expression format of signals that are output from the input device 1099 and the external memory device 1100 and outputting a print signal PS to the printer 1022.

The bus 1097 is a signal line that connects the CPU 1091, the ROM 1092, the RAM 1093, the HDD 1094, the video circuit 1095, and the I/F 1096 to one another, allowing data to be sent and received between them.

The display device 1098 is a device that is constituted of, for example, an LCD (Liquid Crystal Display) monitor or a CRT (Cathode Ray Tube) monitor, and that displays images corresponding to video signals output from the video circuit 1095.

The input device 1099 is a device that is constituted of, for example, a keyboard and a mouse, and that is for generating signals corresponding to operations performed by a user and supplying these to the I/F 1096.

The external memory device 1100 is a device that is constituted of, for example, a CD-ROM (Compact Disk-ROM) drive unit, an MO (Magneto Optic) drive unit, or an FDD (Flexible Disk Drive) unit, and that is for reading data and programs stored on CD-ROM disks, MO disks, or FDs and supplying these to the CPU 1091. If the external memory device 1100 is an MO drive unit or an FDD unit, then it also functions as a device for storing data supplied from the CPU 1091 on an MO disk or an FD.

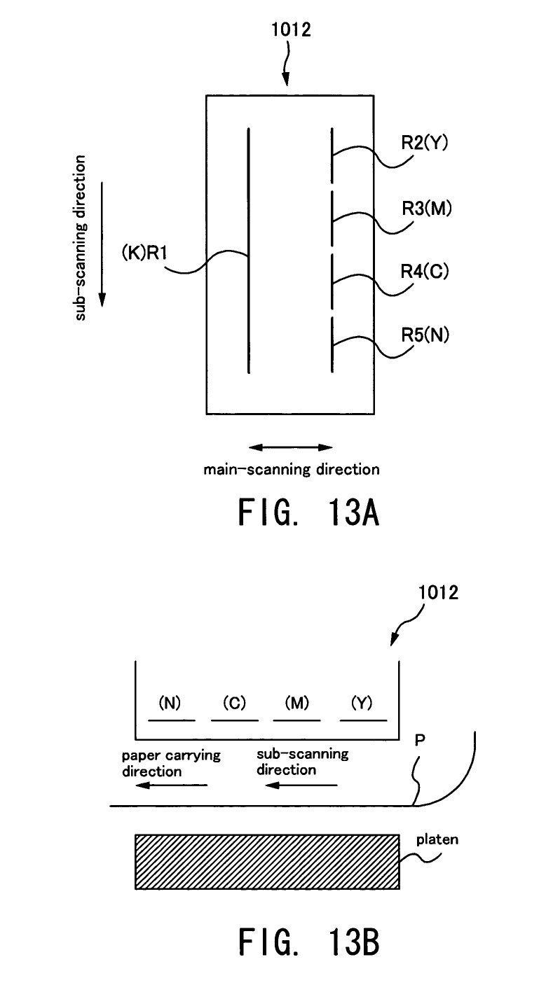

The configuration of the print head 1012 is described next with reference to FIG. 10, FIG. 13A, and FIG. 13B.

As shown in FIG. 10, five ink cartridges 1071 and 1075, namely, a cartridge 1071 containing black (K) ink, a cartridge 1072 containing yellow (Y) ink, a cartridge 1073 containing magenta (M) ink, a cartridge 1074 containing cyan (C) ink, and a cartridge 1075 containing clear (N) ink, are removably mounted to the carriage 1031. It should be noted that the composition of the clear ink and the color inks differs according to the application thereof, and thus is described in detail later.

As shown in FIG. 10, the print head 1012 is provided at a lower section of the carriage 1031. As shown in FIG. 13A, nozzle rows R1 to R5 in which nozzles, functioning as ink ejection locations, are arranged in rows in the direction in which the print paper P is carried are formed in the print head 1012. It should be noted that the configuration of the nozzles is described in detail later.

Piezoelectric elements, which are a type of electrostrictive element with excellent responsiveness, are provided at a lower section of the carriage 1031 and arranged for each nozzle in the nozzle rows R1 to R5, which correspond to each type of ink. The piezoelectric elements are arranged at positions in contact with members forming the ink paths over which ink is guided to the nozzles. When voltage is applied the piezoelectric elements, their crystalline structure is deformed, and thus, they convert the electrical energy to mechanical energy very quickly.

In the third embodiment, voltage of a predetermined duration is applied between electrodes provided on both sides of each piezoelectric element, and thus, the piezoelectric elements expand during application of the voltage and deform one lateral wall of the ink path. As a result, the volume of the ink path is constricted by an amount according to the expansion of the piezoelectric element, and ink corresponding to this amount of constriction is quickly ejected from the tip of a nozzle as an ink droplet. The ink droplet soaks into the print paper P, which is guided along the paper feed roller 1026, thereby forming a dot to carry out printing.

FIG. 13A is a diagram showing an arrangement of nozzles in the print head 1012 (with the nozzles 12 viewed from the perspective of the print paper P). As shown in the figure, the nozzle row R1 for ejecting black (K) ink is formed on the left side of the print head 1012, and the nozzle rows R2 to R5 for ejecting yellow (Y), magenta (M), cyan (C), and clear (N) ink are formed in that order in a row in the sub-operation direction. It should be noted that the nozzle rows R2 to R4 serve as the second nozzle row, and the nozzle row 5 serves as the first nozzle row.

FIG. 13B is a diagram showing a positional relationship between the nozzle rows R2 to R5 and the print paper P during printing. As shown in the figure, the print paper P is carried from right to left in the diagram between the print head 1012 and a platen (a member which is arranged at a position that is in opposition to the print head 1012 and which supports the print paper P such that it is flat), and droplets of ink are discharged from the nozzle rows R2 to R5 of the print head 1012 in that order (the order of YMCN). It is clear from FIG. 13A that the clear (N) ink is arranged on the most downstream side in the sub-scanning direction, that is, the trailing end side in the sub-scanning direction, of the print paper P, and thus, the clear (N) ink is discharged last.

Here, the nozzle rows R1 to R5 are expressed as single line segments in FIG. 13A, but in practice, each line segment is constituted by a plurality of nozzles arranged in a row. It should be noted that instead of the arrangement shown in FIG. 13A, an arrangement in which the nozzle row R1 and the nozzle rows R2 to R5 are left-right inversed is also possible. Further, although it is necessary for the nozzle row R5 to be downstream of the nozzle rows R2 to R4, the order in which the nozzle rows R2 to R4 are arranged can be different from the order shown in FIG. 13A.

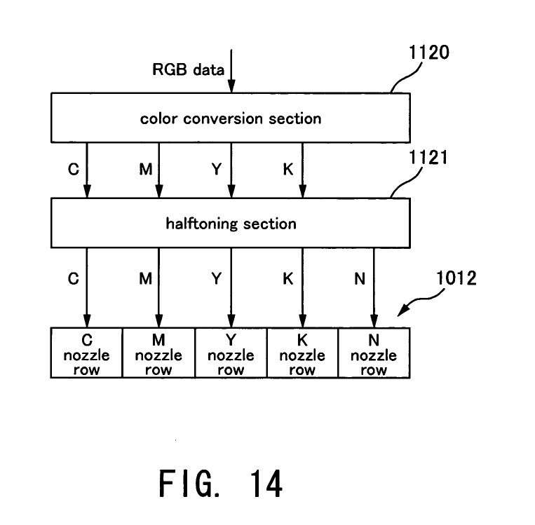

FIG. 14 is a diagram showing functional blocks of the driver software for the printer 1022 that is installed in the computer 1090. As shown in the diagram, the driver software is constituted of a color conversion section 1120 and a halftoning section 1121, and the output of the halftoning section 1121 is supplied to the nozzle rows.

Here, the color conversion section 1120 receives the input of image data such as RGB (Red, Green, Blue) full color image data and converts color data, which constitutes the input image data and which is expressed in the RGB color system, into color data in the CMY color system, which has color components corresponding to the set of color inks. It should be noted that black (K) is used when printing text, for example, and is not used for color printing.

The halftoning section 1121 executes processing such as error diffusion or dithering with respect to image data output from the color conversion section 1120, thereby converting data of multiple gradations (for example, 256 tones) of the CMY colors into binarized bitmap data, for example, expressed by the density of the dots of the CMY colors. Further, when printing text, the character data is subjected to error diffusion and converted into binarized bitmap data for K.

Further, the halftoning section 1121, when creating bitmap data in the case of color printing, creates N dot data indicating the dots of clear ink in addition to the CMY dot data indicating the dots of CMY. For example, in the case of (1-A)—correcting unevenness in luster—discussed above, the N dot data is set such that, considering a single or a plurality of pixels, clear ink is discharged in a supplementary manner such that the amount of discharged color ink in those dots or dot groups is within a predetermined range. It should be noted that the bitmap data output from the halftoning section 1121 includes the C, M, Y, K, and N bitmap data mentioned above.

The bitmap data output from the halftoning section 1121 are supplied to the print head 1012, and droplets of C, M, Y, and N ink are ejected according to the bitmap data when printing an image, whereas droplets of K ink are ejected when printing text, thus forming dots on the print paper P.

The operation of the third embodiment is described next. It should be noted that in the following description, first, the operation of the case corresponding to (1-A) “correcting unevenness in luster” mentioned above is described, and then the operations of the cases corresponding to (1-B) “correcting unevenness in luster” and (3) “improving the printing speed” are described.

First the operation of discharging clear ink to areas of low dot density in order to correct unevenness in luster discussed in (1-A) is described.

In the case of (1-A), ink obtained by dissolving a transparent polymer in water, which is a solvent, is employed as the clear ink, and inks obtained by dissolving pigments of the respective colors in water, which is a solvent, are employed as the color inks.

When the input device 1099 of the computer 1090 is operated to request activation of the application program, the CPU 1091 reads out that program from the HDD 1094 and executes it. As a result, the application program is activated and it becomes possible to create or edit image data.

When a request to print a created image is made via the input device 1099 after an image has been drawn or edited using this application program, the CPU 1091 supplies the created image data to the driver software.

It should be noted that the image data are data expressed in the RGB color system, and for example, the resolution in the height and width direction of the image data is 360 dpi (Dots Per Inch).

The color conversion section 1120 of the driver software converts the image data that are received from the application program into image data expressed in the CMY color system. It should be noted that it employs, for example, an LUT (Look Up Table) stored in the HDD 1094 for this conversion process.

When conversion to the CMY color system has finished, the color conversion section 1120 executes error diffusion processing or dithering with respect to the image data (256-tone data) expressed in the CMY color system obtained as a result of the conversion, thus creating binarized bitmap data for each CMY color. It should be noted that at this time, the resolution of the image is converted from 360×360 dpi in height and width for when it was input into 720×720 dpi in height and width, which corresponds to the resolution of the print head 1012.

The halftoning section 1121 then creates bitmap data for the clear ink such that dots of clear ink are formed at areas where the density of the dots of color ink is low. That is, when focusing on all of the inks CMY and N, the halftoning section 121 creates bitmap data for the clear ink such that the amount of ink (mass or volume) per unit area that lands in each section of the print paper P is within a fixed range. It should be noted that the amount of clear ink that is discharged is suitably set according to the degree of luster of the dots formed by the clear ink and the state of actual unevenness in luster when printed.

It should be noted that clear ink has a greater degree of luster than the same amount of color ink, and thus it is not necessary to discharge the same amount of clear ink as color ink. Therefore, it is possible to set the bitmap data for the clear ink to a resolution that is lower than 720 dpi in the height and width directions. That is, it is only necessary that clear ink is discharged at a resolution that allows the foregoing conditions to be satisfied.

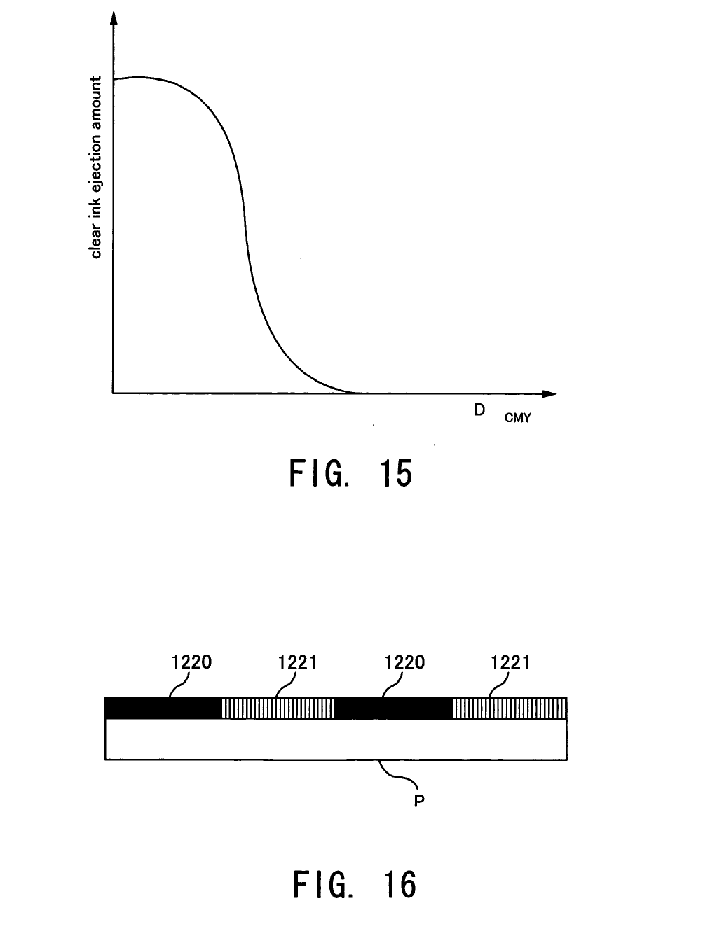

More specifically, for example, when focusing on a single or a plurality of pixels, supposing that the total amount of CMY ink that is discharged for that pixel (group) is D_{CMY}, the amount of clear ink that is ejected is determined based on the curved line shown in FIG. 15 in correspondence with the discharged amount D_{CMY}. That is, when D_{CMY} is small, the amount of clear ink that is ejected (or the density of dots formed) is increased, and when D_{CMY} is large, the amount of clear ink that is ejected (or the density of dots formed) is decreased. Further, when creating a piece of bitmap data for clear ink, if the number of pixels that are focused on increases or decreases, then it is possible to change the resolution of the bitmap data for the clear ink.

The bitmap data for the color ink and the clear ink created in this manner are output from the halftoning section 1121 and supplied to the printer 1022 via the I/F section 1096. The CPU 1041 in the printer 1022 receives these data. The CPU 1041 drives the paper feed motor 1023 to draw out a single sheet of print paper P and send the paper to the print start position. Then, when the print start position of the print paper P has been moved to directly below the print head 1012, the bitmap data that have been received are supplied to the print head 1012 via the head drive circuit 1052 and printing is started. At this time, the bitmap data of the clear ink is supplied to the nozzle row R5 of the print head 1012, and the other bitmap data are respectively supplied to the nozzle rows R2 to R4 for each color.

When printing is started, the CPU 1041 repeatedly performs the operation of scanning the carriage 1031 in the main scanning direction while ejecting color ink from the nozzle rows R2 to R4 and clear ink from the nozzle row R5 and intermittently carrying the print paper P in the sub-scanning direction. At this time, the color ink is printed in the order of Y, M, C to create overlapping color layers, and then lastly N ink is printed. As a result, the clear ink is thus printed after the color ink has sufficiently set, and therefore, it is possible to reduce the effect that clear ink has on color ink, thereby allowing favorable coloring to be achieved.

FIG. 16 is a schematic view of a cross section of the print paper P printed according to the present embodiment.

As shown in FIG. 16, dots 1220 of color ink are formed on the surface of the print paper P, and dots 1221 of clear ink are formed in regions to which little or no color ink adheres. Thus, the amount of ink that adheres to the surface of the print paper P becomes substantially uniform, thereby reducing differences in the light reflectivity, that is, unevenness in luster. It should be noted that this figure is only a schematic representation, and clear ink is not discharged to all regions to which color ink has not been discharged as shown in the figure.

As described above, in the third embodiment, clear ink is discharged in a supplementary manner to regions where little color ink has been discharged, and thus the degree of luster of these areas is raised and unevenness in luster can be kept from occurring. Further, the clear ink is printed after the color ink has sufficiently set because the nozzle row R5 is arranged on the most downstream side of the print head 1012, and thus it is possible to reduce the effect that clear ink has on the color ink, allowing favorable coloring to be achieved.

It should be noted that clear ink generally has a higher degree of luster than an equal amount of color ink, and thus unevenness in luster can be sufficiently corrected even if the number of nozzle groups constituting the nozzle row R5 is less than those in the nozzle rows R2 to R4 for the color ink. Further, even if the degree of luster of the clear ink is equal to or less than that of the other inks, the above can still be adopted by increasing the amount of clear ink that is ejected.

It should be noted that in the third embodiment described above, the position and the discharged amount of clear ink were determined such that the total amount of clear ink and color ink that is discharged per unit area in every region of the image is within a predetermined range. However, as discussed above, unevenness in luster is particularly noticeable near the border between areas where color ink has been discharged and areas where color ink has not been discharged, and in view of this, it is also possible to discharge clear ink around these areas. More specifically, it is possible to find the D_{CMY} for the entire image data, spatially differentiate the two-dimensional data thus obtained, and discharge clear ink to regions whose value is large but whose DCMY value is small (regions adjacent to areas where color ink has been discharged). By doing this, it is possible to effectively prevent the occurrence of unevenness in luster and also to keep the amount of clear ink consumption low.

The operation of the case corresponding to (1-B), that is, a case where clear ink is discharged over the entire image in a so-called uniform overcoating for the purpose of “correcting unevenness in luster” is described next.

In the case of (1-B), an overcoat fluid having the ability to form a film, such as a solution in which a transparent polymer has been dissolved in water, which is a solvent, is used as the clear ink.

On the other hand, solutions in which pigments of the respective colors have been dissolved in water, which is a solvent, are used as the color inks.

Since clear ink is uniformly discharged over the entire image in the case of (1-B), it is not necessary for the halftoning section 1121 to create bitmap data for the clear ink according to DCMY as in the processing related to (1-A). That is, in this case, it is only necessary for the bitmap data for the clear ink to be fixed data in which the bits for clear ink are set to “1” at predetermined intervals.

More specifically, in the case of (1-B), the halftoning section 1121 creates bitmap data in which “1” is set at a constant interval regardless of the state of the pixels of CMY, and supplies the bitmap data to the nozzle row R5.

In the printer 1022, color ink is ejected from the nozzle rows R2 to R4 according to the bitmap data for CMY that are supplied form the halftoning section 1121, and color layers are superposed in the order of CMY onto the print paper P. Then, after each CMY ink has sufficiently set on the print paper P, clear ink is ejected onto these dots from the nozzle row R5, forming an overcoating.

It should be noted that other operations are the same as those relating to the case of (1-A).

As described above, according to the present embodiment, the clear ink is ejected from the nozzle row R5 over the dots after CMY inks have sufficiently set on the print paper P, and forms an overcoating, and thus it is possible to reliably eliminate unevenness in luster as well as to protect the color ink due to the film that is formed by the clear ink and thus increase the light-resistance properties.

The operation corresponding the case of (3) “improving the printing speed” is described next.

The composition of the color ink and the clear ink, and the operation of the halftoning section 1121, are different in the case corresponding to (3) “improving the printing speed” compared to the case of (1-A) “correcting unevenness in luster” discussed above. Therefore, the following description focuses on the composition of the inks and the operation of the halftoning section 1121.

First, in the case of (3) “improving the printing speed,” the color ink is, for example, an aqueous ink that includes color material, and the clear ink is, for example, water which serves as a solvent.

In the case of (1-A) “correcting unevenness in luster,” clear ink is discharged to regions in which color ink has not been discharged, but in the case corresponding to (3) “improving the printing speed,” it is instead necessary to discharge clear ink to regions in which color ink has been discharged and moreover in which solid printing is performed.

Therefore, in the case of (3), the halftoning section 1121, when creating bitmap data for the clear ink, first specifies regions in which solid printing is performed, and then discharges clear ink (sets the bitmap data to “1”) if, in the specified regions, either one of the pixels of color ink that are adjacent to the pixel of clear ink in the height direction (in the sub-scanning direction) is “1,” that is, if ink of any color of CMY is to be discharged. On the other hand, clear ink is not discharged (the bitmap data is set to “0”) if both adjacent color-ink pixels are “0,” that is, if no color of CMY is to be discharged.

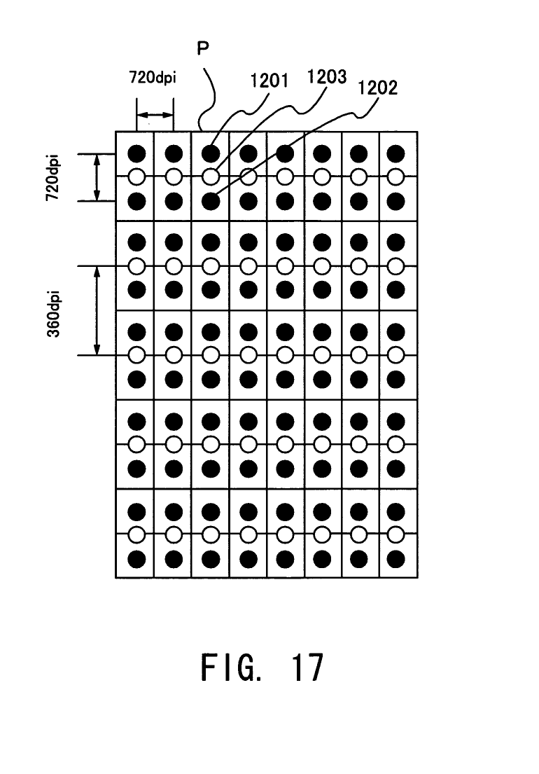

More specifically, if, as shown in FIG. 17, the resolution of the color ink is 720 dpi both in the height and width directions and the resolution of the clear ink is 360 dpi in the height direction and 720 dpi in the width direction, then a dot 1203 corresponding to the clear ink (shown by a white circle in FIG. 17) is set to “1” when at least one of the dots 1201 and 1202 (shown by black circles in FIG. 17) corresponding to the color ink is “1,” and when both are “0,” the dot 1203 corresponding to the clear ink is set to “0.”

The bitmap data of the color inks and the clear ink created in this manner are supplied to the printer 1022, color ink is ejected from the nozzle rows R2 to R4 in the order of CMY to form overlapping color layers on the print paper P, and then clear ink is ejected from the nozzle row R5.

As a result, by ejecting clear ink after the color ink, which is discharged first, near the color ink, the dots of color ink are intentionally made to bleed and thus their dot size can be increased, and therefore, it is possible to perform solid printing over a wide region using a small amount of ink. Further, since it is not necessary to repeatedly perform printing, the printing speed can be increased.

### Fourth Embodiment

A fourth embodiment of the present invention is described next. The only difference between this embodiment and the third embodiment is that the configuration of a print head 1012A differs from that of the print head 1012, and therefore, the following description addresses only the configuration of the print head 1012A.

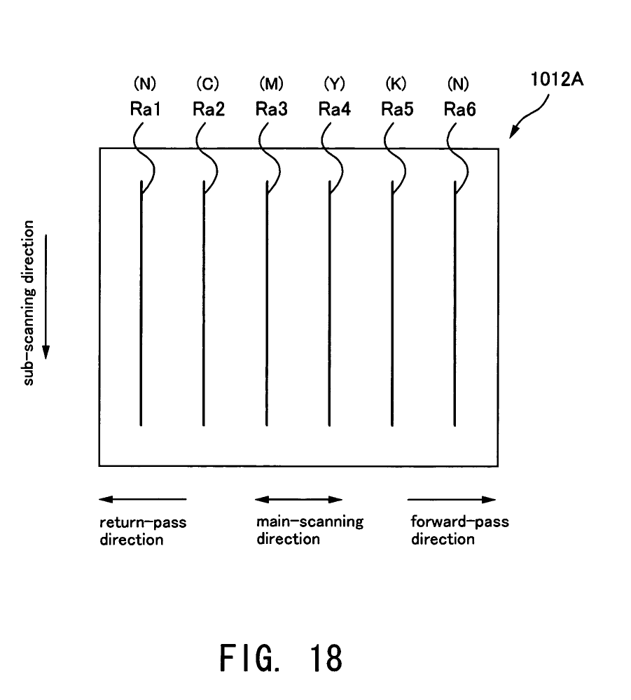

FIG. 18 is a diagram showing an example of a configuration of the print head 1012A according to the fourth embodiment of the present invention. As shown in the diagram, in this embodiment, the nozzle rows Ra1 to Ra6 are arranged next to one another in the main-scanning direction. More specifically, the nozzle rows Ra1 to Ra6 are arranged from left to right in FIG. 18, and the nozzle rows Ra1 and Ra6 are for clear (N) ink and the nozzle rows Ra2 to Ra5 are for cyan (C), magenta (M), yellow (Y), and black (K) ink, respectively. Further, in this embodiment, printing is carried out both in the forward pass and in the return pass when the print head 1012A is moved back and forth in the main-scanning direction. It should be noted that the nozzle rows Ra2 to Ra5 serve as second nozzle rows, and the nozzle rows Ra1 and Ra6 serve as first nozzle rows.

The operation of the above-mentioned fourth embodiment is described next.

In the fourth embodiment, the operation of the color conversion section 1120 and the halftoning section 1121 shown in FIG. 14 is the same as that of the preceding embodiment, but the procedure according to which ink is ejected by the print head 1012A is different. Accordingly, the operation by which ink is ejected by the print head 1012A is described separately for each case.

First, in the case of (1-A), bitmap data for the clear ink and the color ink are created in the same manner as described above, and supplied to the printer 1022. The printer 1022 supplies the bitmap data that are received from the computer 1090 to the nozzle rows Ra2 to Ra5 for each color and drives the carriage motor 1024 so as to carry out the printing process.

More specifically, when moving (scanning) the carriage 1031 in the forward-pass direction as shown in FIG. 18, printing is carried out using the nozzle rows Ra1 to Ra5 only, without using the nozzle row Ra6. That is, in printing in the forward-pass direction, printing is carried out with the color ink using the nozzle rows Ra5, Ra4, Ra3, and Ra2, in that order, and then printing is carried out by ejecting clear ink from the nozzle row Ra1 to the areas where color ink is sparse.

On the other hand, in the return pass, printing is carried out using the nozzle rows Ra2 to Ra6 only, without using the nozzle row Ra1. That is, in printing in the return-pass direction, printing is carried out with the color ink using the nozzle rows Ra2, Ra3, Ra4, and Ra5, in that order, and then printing is carried out by ejecting clear ink from the nozzle row Ra6 to the areas where color ink is sparse.

By repeating this forward and back operation, color ink and clear ink are applied to the print paper P, and printing of an image is thus completed.

According to the above-mentioned fourth embodiment, clear ink is printed using the nozzle row Ra1 in the forward pass and is printed using the nozzle row Ra6 in the return pass, and in this way, clear ink can be printed after the color ink. It is therefore possible to print with clear ink after the color ink has sufficiently set, and thus the coloring properties etc. can be improved.

The operation for the case of (1-B) is described next.

In the case of (1-B), it is necessary to uniformly apply the clear ink over the entire image as with the case discussed above, and thus clear ink is applied using bitmap data in which the data is set to “1” at constant intervals.

It should be noted that in the operation during printing, as with the case described above, printing in the forward pass is performed using the nozzle rows Ra1 to Ra5 and printing in the return pass is performed using the nozzle rows Ra2 to Ra6.

According to the fourth embodiment, clear ink can be applied in a uniform overcoating after the color ink has been applied, and thus unevenness in luster can be reliably reduced.

The operations for the cases corresponding to (2-B) “correcting ink bleeding, etc.” and (3) “improving the printing speed” are described next.

The cases (2-B) and (3) are different from the case of (1-A) in that bitmap data are created such that clear ink is discharged to or near pixels where color ink is to be discharged. Further, as regards (3), the operation is performed only with respect to regions where solid printing is performed.

It should be noted that in the operation during printing, as with the case described above, printing in the forward pass is performed using the nozzle rows Ra1 to Ra5, and printing in the return pass is performed using the nozzle rows Ra2 to Ra6.

According to this embodiment, in the case of (2-B), clear ink is discharged near dots formed by color ink, and thus the bleeding, etc. of ruled lines can be corrected.

Further, in the case of (3), clear ink is discharged near dots formed by color ink so as to induce bleeding, and thus the printing speed can be increased.

It should be noted that the above-mentioned fourth embodiment was described using an example in which printing is carried out both in the forward and return passes of the carriage 1031, but the present invention is also applicable to printers that print, for example, only in one direction of either the forward pass or the return pass. For example, if printing is carried out in the forward pass only, then it is possible to adopt a configuration in which the nozzle row Ra6 is not provided and printing is carried out using the nozzle rows Ra1 to Ra5 only, such that clear ink is printed by the nozzle row Ra1 after printing of the color ink by the nozzle rows Ra2 to Ra5 has finished. Alternatively, if the printer is to carry out printing only in the return pass, then it is possible to adopt a configuration in which the nozzle row Ra1 is not provided and printing is carried out using the nozzle rows Ra2 to Ra6 only, such that clear ink is printed by the nozzle row Ra6 after printing of the color ink by the nozzle rows Ra2 to Ra5 has finished.

Third and fourth embodiments of the present invention have been described above, but the present invention can take on various forms other than the above. For example, the four colors CMYK were used as the ink, but it is also possible to use light color inks (light cyan (LC), light magenta (LM), dark yellow (DY)) in addition to these colors.

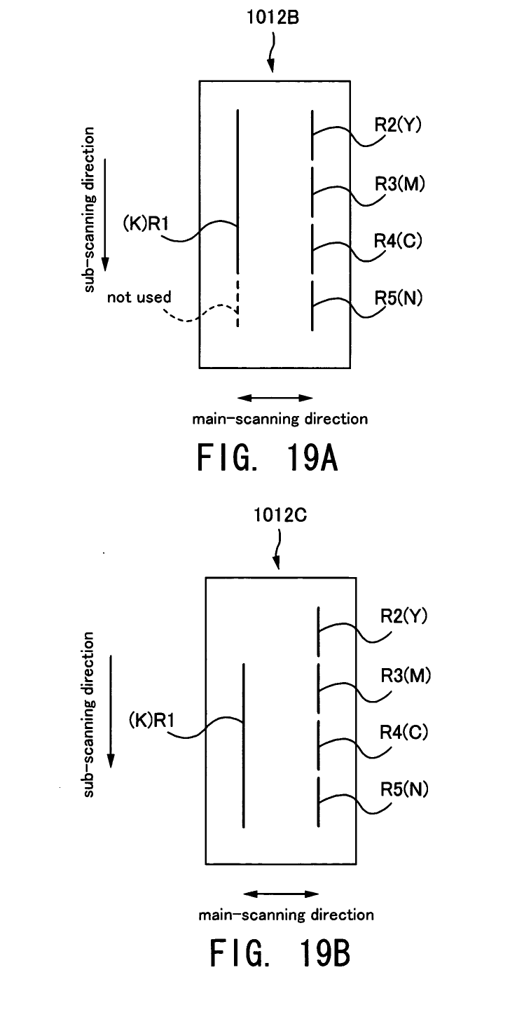

Further, in the third and fourth embodiments, the three colors CMY were used when printing images, but as mentioned above, it is also possible to use light color inks and also use black (K) ink. It should be noted that in this case, if a configuration in which the nozzles are arranged in the same manner as in the embodiment shown in FIG. 13A is adopted, then, as with the print head 1012B shown in FIG. 19A, printing may be performed such that, as regards the nozzle row R1, only the nozzle group within the range corresponding to the nozzle rows R2 to R4 is used, and the nozzle group within the range corresponding to the nozzle row R5 is not used, thereby allowing clear ink to be discharged after the black (K) ink has been discharged. Further, as with the print head 1012C shown in FIG. 19B, it is also possible not to provide the nozzle group of the nozzle row R1 within the range corresponding to the nozzle row R5 in the print head 1012.

Further, specific examples were provided for the composition of the ink, but the present invention is not limited to the specific examples that have been provided.

Further, a printer 1022 provided with a head that ejects ink using piezoelectric elements is employed as discussed above, but it also possible to employ various ejection drive elements other than piezoelectric elements. For example, the present invention is also applicable to printers provided with ejection drive elements of a type that eject ink by bubbles generated within the ink path by passing a current through a heater arranged in the ink path.

Furthermore, in the third and fourth embodiments, the processing of the color conversion section 1120 and the halftoning section 1121 was executed by driver software stored in the HDD 1094 (or the external memory device 1100). However, it is also possible to store a program having equivalent functions on the P-ROM 1043 of the printer 1022 and to execute the processing of the color conversion section 1120 and the halftoning section 1121 using this program, or to carry out processing by sharing the processes between the driver software and the printer 1022.

### Fifth Embodiment

A fifth embodiment of the present invention is described next.

The printing apparatus according to the fifth embodiment also adopts a configuration in which nozzle rows R2 to R4 for ejecting yellow (Y), magenta (M), and cyan (C) ink serve as the second nozzle rows and the nozzle row 5 for ejecting clear (N) ink serves as the first nozzle row.

In the fifth embodiment, the first nozzle row is arranged on the upstream side and on the downstream side of the second nozzle rows in the carrying direction of the medium.

Ink not having color material (clear ink) is suitably ejected from the first nozzle rows.

In the fifth embodiment, if, for example, clear ink that is preferably ejected in advance of the color ink is employed, then the clear (N) ink is first discharged onto the print paper P from the first nozzle row and then color ink is discharged in the order of Y, M, and C to form overlapping color layers. As a result, color ink is discharged after clear ink has been discharged and the properties of the print paper P have been improved, and thus it is possible to prevent bleeding as well as to achieve an improvement in the coloring, setting, or drying properties.

On the other hand, if, for example, clear ink that is preferably ejected after the color ink is employed, then the color ink is first ejected to form overlapping color layers, and then lastly, N ink is ejected from the first nozzle row. Clear ink is thus printed after the color ink has sufficiently set, and therefore, the influence that the clear ink has on the color ink can be reduced, thus allowing favorable coloring to be achieved.

1. A printing apparatus comprising:
a carrying mechanism for carrying a medium in a carrying direction; and
a print head having a plurality of nozzles for ejecting ink to form dots on the medium that is carried by said carrying mechanism,
wherein said print head includes:
a first nozzle row having a plurality of nozzles that are for ejecting ink not having color material and that are arranged in said carrying direction; and
a second nozzle row having a plurality of nozzles that are for ejecting ink having color material and that are arranged in said carrying direction, and
wherein said first nozzle row is arranged at least on one of an upstream side and a downstream side of said second nozzle row in said carrying direction.

2. A printing apparatus according to claim 1, wherein
said first nozzle row is arranged on the upstream side of said second nozzle row in said carrying direction.

3. A printing apparatus according to claim 2, wherein
said second nozzle row has a plurality of nozzle rows each for ejecting ink of a different color.

4. A printing apparatus according to claim 2, wherein
said ink not having color material is an ink that is preferably ejected in advance of said ink having color material.

5. A printing apparatus according to claim 4, wherein
said ink not having color material is an ink that chemically reacts with said ink having color material.

6. A printing apparatus according to claim 5, wherein
said ink not having color material is an ink that is for preventing bleeding, improving coloring properties, improving setting properties, or improving drying properties.

7. A printing apparatus according to claim 1, wherein
said first nozzle row is arranged on the downstream side of said second nozzle row in said carrying direction.

8. A printing apparatus according to claim 7, wherein
said second nozzle row has a plurality of nozzle rows each for ejecting ink of a different color.

9. A printing apparatus according to claim 7, wherein
said ink not having color material is an ink that is preferably printed after said ink having color material.

10. A printing apparatus according to claim 9, wherein
said ink not having color material is an ink that is for preventing bleeding, improving coloring properties, improving setting properties, or improving drying properties.

11. A printing apparatus according to claim 1, wherein
said first nozzle row is arranged on the upstream side and on the downstream side of said second nozzle row in said carrying direction, and said ink not having color material is suitably ejected from these first nozzle rows.

12. A printing apparatus comprising:
a carrying mechanism for carrying a medium in a carrying direction; and
a print head that has a plurality of nozzles for ejecting ink to form dots on the medium carried by said carrying mechanism, and that moves in a predetermined direction to perform printing,
wherein said print head includes:
a first nozzle row having a plurality of nozzles that are for ejecting ink not having color material and that are arranged in said carrying direction; and
a second nozzle row having a plurality of nozzles that are for ejecting ink having color material and that are arranged in said carrying direction, and
wherein said first nozzle row is arranged at least on one of an upstream side and a downstream side of said second nozzle row in said predetermined direction.

13. A printing apparatus according to claim 12, wherein
said first nozzle row is arranged on the downstream side of said second nozzle row in said predetermined direction.

14. A printing apparatus according to claim 12, wherein
said first nozzle row is arranged on the upstream side of said second nozzle row in said predetermined direction.

15. A printing apparatus according to claim 12, wherein
said first nozzle row is arranged on the upstream side and on the downstream side of said second nozzle row in said predetermined direction, and said ink not having color material is suitably ejected from these first nozzle rows.

16. A printing apparatus comprising:
a carrying mechanism for carrying a medium in a carrying direction; and
a print head that has a plurality of nozzles for ejecting ink to form dots on the medium carried by said carrying mechanism, and that moves in a predetermined direction and an opposite direction thereto to perform printing,
wherein said print head includes:
a first nozzle row having a plurality of nozzles that are for ejecting ink not having color material and that are arranged in said carrying direction; and
a second nozzle row having a plurality of nozzles that are for ejecting ink having color material and that are arranged in said carrying direction,
wherein said first nozzle row is arranged on both an upstream side and a downstream side of said second nozzle row in said predetermined direction, and
wherein during printing, said second nozzle row and either one of the first nozzle rows arranged on said upstream side and said downstream side are used to perform printing.

17. A printing apparatus according to claim 16, wherein during printing, said second nozzle row and the first nozzle row, of the first nozzle rows arranged on said upstream side and said downstream side, that is positioned on a front side in the direction in which said print head moves are used to perform printing.

18. A printing apparatus according to claim 16, wherein
during printing, said second nozzle row and the first nozzle row, of the first nozzle rows arranged on said upstream side and said downstream side, that is positioned on a rear side in the direction in which said print head moves are used to perform printing.

19. A print head having a plurality of nozzles for ejecting ink to form dots on a medium, comprising:
a first nozzle row having a plurality of nozzles that are for ejecting ink not having color material and that are arranged in a carrying direction in which the medium is carried; and
a second nozzle row having a plurality of nozzles that are for ejecting ink having color material and that are arranged in said carrying direction,
wherein said first nozzle row is arranged at least on one of an upstream side and a downstream side of said second nozzle row in said carrying direction.

20. A print head according to claim 19, wherein
said first nozzle row is arranged on the upstream side of said second nozzle row in said carrying direction.

21. A print head according to claim 19, wherein
said first nozzle row is arranged on the downstream side of said second nozzle row in said carrying direction.

22. A print head according to claim 19, wherein
said first nozzle row is arranged on the upstream side of said second nozzle row in said carrying direction and on the downstream side of said second nozzle row in said carrying direction, and said ink not having color material is suitably ejected from these first nozzle rows.

23. A print head having a plurality of nozzles for ejecting ink to form dots on a medium, comprising:
a first nozzle row having a plurality of nozzles that are for ejecting ink not having color material and that are arranged in a carrying direction in which the medium is carried; and
a second nozzle row having a plurality of nozzles that are for ejecting ink having color material and that are arranged in said carrying direction,
wherein said first nozzle row is arranged at least on one of an upstream side and a downstream side of said second nozzle row in said carrying direction, and
wherein said ink not having color material is ejected from said first nozzle row before ink is ejected from said second nozzle row.

24. A print head having a plurality of nozzles for ejecting ink to form dots on a medium, comprising:
a first nozzle row having a plurality of nozzles that are for ejecting ink not having color material and that are arranged in a carrying direction in which the medium is carried; and
a second nozzle row having a plurality of nozzles that are for ejecting ink having color material and that are arranged in said carrying direction,
wherein said first nozzle row is arranged at least on one of an upstream side and a downstream side of said second nozzle row in said carrying direction, and
wherein said ink not having color material is ejected from said first nozzle row after ink is ejected from said second nozzle row.

25. A printing method comprising:
a step of carrying a medium in a carrying direction;
a step of ejecting ink not having color material onto the medium; and
a step of ejecting ink having color material after the ink not having color material has been ejected onto the medium.

26. A printing method comprising:
a step of carrying a medium in a carrying direction;
a step of ejecting ink having color material onto the medium; and
a step of ejecting ink not having color material after the ink having color material has been ejected onto the medium.
